(19) United States
(12) Patent Application Publication
(10) Pub. No.: US 2009/0112134 A1
(43) Pub. Date: Apr. 30, 2009

(54) DEVICES AND METHOD FOR APPLYING VIBRATIONS TO JOINTS

(75) Inventor: Yuval Avni, Givatayim (IL)

Correspondence Address: CANTOR COLBURN, LLP, 20 Church Street, 22nd Floor, Hartford, CT, 06103, US

(73) Assignee: KINETICURE LIMITED, CHANNEL ISLANDS (GB)

(21) Appl. No.: 11/814,641

(22) PCT Filed: Jan. 4, 2006
(86) PCT No.: PCT/IL06/00016

§ 371 Date: Jul. 7, 2008

(30) Foreign Application Priority Data
Jan. 24, 2005 (IL) 166468
May 10, 2005 (IL) 168520

(51) Int. Cl. A61H 1/00; A61F 13/00

(52) U.S. Cl. 601/15; 601/46; 602/60

(57) ABSTRACT

Devices and method for introducing vibrations to a joint or joint area of a user of the device, the device comprising flexible or rigid portions or members connected there between and having a shape substantially fitting the area adjacent a joint, flexible members for attaching the rigid portions or members to the area adjacent the joint, and a vibrating mechanism for introducing vibration to the joint. The devices can apply firmer grip to the area around a joint than to the joint itself, thus activate vibrations along multiple vectors and affect multiple elements of the joint and joint area and induce healing of the joint and joint area.

### RELATED APPLICATIONS

This application claims priority from Israeli patent application serial number 166468 titled “DEVICES AND METHOD FOR APPLYING VIBRATIONS TO JOINTS” filed Jan. 24, 2005, and from Israeli patent application serial number 168520 titled “DEVICES AND METHOD FOR APPLYING VIBRATIONS TO JOINTS” files May 10, 2005, both applications are incorporated herein by reference.

### BACKGROUND OF THE INVENTION

1. Field of the Invention

The present invention relates to medical devices in general, and to a method and devices for reducing pain, improving function and delaying disabilities related to arthritis and chronic joint symptoms, in particular.

2. Discussion of the Related Art

Arthritis is a common name for over a hundred types of diseases, including Osteoarthritis, Rheumatoid Arthritis, and Fibromyalgia to name the three most common types of Arthritis.

Osteoarthritis (sometimes called degenerative joint disease) is the most common type of arthritis, especially among older people. Osteoarthritis is joint disease which is primarily a disorder of the cartilage and subchondral bone. Healthy cartilage allows bones to glide over one another and absorbs energy from the shock of physical movement. The events leading to Osteoarthritis result in the remodeling of the moveable joints thus allowing the deformed bones to rub together with the joint having deteriorating cartilage, causing pain, swelling, and loss of motion of the joint. Over time, the joint may lose its normal shape. Also, bone spurs may grow on the edges of the joint. Bits of bone or cartilage can break off and float inside the joint space. This causes additional pain and damage. Symptoms of osteoarthritis usually include joint pain, stiffness, and limited movement.

Rheumatoid arthritis (RA) is a chronic disease, mainly characterized by inflammation of the lining of the joints. It can lead to long-term joint damage, resulting in chronic pain, loss of function and disability. Rheumatoid arthritis progresses in three stages. The first stage is the swelling of the lining, causing pain, warmth, stiffness, redness and swelling around the joint. Second is the rapid division and growth of cells, which causes the lining to thicken. In the third stage, the inflamed cells release enzymes that may digest bone and cartilage, often causing the involved joint to lose its shape and alignment, more pain, and loss of movement. RA is a systemic disease, which means it can affect internal organs in the body, and a chronic disease, which may persist indefinitely.

Fibromyalgia (FM) is manifested as widespread pain affecting muscles and attachments to the bone. The patient may also exhibit tender points, specific regions that hurt when pressure is applied. Other symptoms can include fatigue, sleep disturbances, migraine headaches, irritated bowel syndrome, chest pain and nervous system symptoms such as depression.

Arthritis and other rheumatic conditions are among the most common chronic diseases, affecting over 70 million U.S. adults in 2004, and comprise the leading cause of disability among U.S. adults. Arthritis prevalence increases with age, affecting approximately 60% of the U.S. population aged 65 or older. As a result of better identification and treatment of other chronic diseases and lower mortality from infectious diseases, adults are living longer, and the population is aging. For this reason, the number of persons living with nonfatal but disabling conditions such as arthritis or chronic joint symptoms (CJS) might be increasing. If arthritis prevalence rates remain stable, the number of affected persons aged 65 years and over will nearly double by 2030.

Multiple studies have shown connection between exposure to vibrations when a joint is in strenuous state and Osteoarthritis. This led to the creation of standards for the frequency, amplitude and length of exposure to vibrations which are considered safe for usage by a human being.

Most Arthritis treatment programs include a combination of medication, exercise, relaxation, use of heat and cold, joint protection techniques, and sometimes surgery. However, the exercise must be balanced with rest for the painful joints.

All the abovementioned treatments for arthritis should be carefully balanced, closely monitored and comply with the patient's life style. In addition, the treatments have at most temporary and partial success in treating arthritis. There is therefore a need for an innovative treatment for arthritis that helps in reducing pain, improving function, and delaying disability. The treatment should be non-invasive and medication free, enable the patient to carry on with his or her lifestyle, not conflict with other treatments the patient might be undergoing and be easy to use. The treatment should be pleasant, comforting and have immediate as well as prolonged effect.

### SUMMARY OF THE PRESENT INVENTION

It is an object of the present invention to provide a novel method and device for introducing vibrations to joints of patients suffering from arthritis, which overcomes the disadvantages of the prior art. In accordance with the present invention, there is thus provided a device for introducing vibrations to a joint or a location in the body of a user of the device, the device comprising one or more wrapping members having a shape substantially fitting the joint and the area adjacent the joint; and a vibrating mechanism for introducing vibrations to the joint. The wrapping member can comprises two or more rigid portions connected there between and having a shape substantially fitting the area adjacent the joint; and one or more attachment members for attaching the one or more wrapping members to the area adjacent the joint. Within the device, the wrapping member comprises a flexible member substantially fitting the area adjacent the joint. The flexible member can comprise an opening such that when the joint is flexed, the joint or a part thereof protrudes through the opening. Within the device the flexible member comprises loose material, preshaped material, additional material, or stitches to enable the user to flex or relax the joint. The device can further comprise one or more attachment members for attaching the one or more wrapping members to the area adjacent the joint. Within the device, the attachment member comprises one or more straps and a fastening mechanism, the strap is connected to the one or more flexible members and comprises one or more parts of the fastening mechanism. The fastening mechanism can comprise one or more pairs of patches, wherein within each pair one patch carries hooks and the other patch carries loops. Alternatively, the fastening mechanism is a buckle. Within the device the vibrations can be introduced intermittently. Within the device, the rigid portions comprise a single piece brace. The single piece brace is preferably having a substantially elongated rectangular shape having a curvature to fit the area adjacent the joint. The rigid portions are positioned such that a fixed angle is formed between two body parts adjacent the joint of the user. The fixed angle is between about 20 and about 190 degrees. Within the device, the flexible member comprises one or more fastening elements, such as a strap. The device preferably comprises an opening located within one of the rigid portions for placing the vibrating mechanism there within. Within the device, the rigid portions are comprised of a single molded element connected by a connecting portion. Alternatively, the rigid portions of the device comprise two or more rigid members, optionally connected by a pivot. Within the device, the rigid members are moveable around the axis created by the pivot such that an angle is formed between the two body parts adjacent the joint of the user. The device can further comprise a latch and a lock enabling the user to change the angle formed between two body parts adjacent the joint thereby moving the rigid members relatively to each other. The vibrating mechanism can be attached to the one or more wrapping members. The vibrating mechanism optionally comprises a power source, a vibrating assembly, and/or a controller for providing vibrations. The controller can activate and deactivate the vibrating assembly, or provide intermittent vibrations, or provide vibrations according to a predetermined protocol, the vibrations are to be delivered to the joint of the user. The predetermined protocol can comprise the activation times, activation periods, frequency, or amplitude for the vibrating assembly. Within the device, the vibrating mechanism optionally comprises a piezoelectric actuator or an Electric Active Polymer actuator. The piezoelectric actuator or the Electric Active Polymer actuator generates vibrations in ultrasonic frequencies applied to the joint and a location in the vicinity of the joint of the user. The power source can comprise a portable power supply, or a connection to a fixed power supply. The vibrating assembly can comprise an energy delivery mechanism to actuate the vibrating assembly, such as a motor. The vibrating assembly can further comprise a shaft to rotate about its axis and a weight to provide a vibration to be delivered to the joint of the user. The device can further comprise a lining, optionally comprising a back member and a front member connected along the edges forming a cavity, or alternatively two or more compartments. The lining can further comprise a port to allow the filling or draining of the lining. Alternatively, the lining can comprise a pump to inflate or deflate the lining, and a port to be connected to a pump to inflate or deflate the lining. The lining is preferably made of permeable or disposable material, and optionally comprises an opening fitted in size and location to an opening in the rigid portions. The lining optionally contains fluid, gel, or soft fabric, and can be inflated, prior to or after attaching the device to the joint of the patient. The lining can alternatively be heated or cooled prior to attaching the device to the joint of the patient. The device can further comprise a container of gas for cooling the contents of the internal lining member, and a connection mechanism to transfer gas from the container to the internal lining. Within the device, the internal lining can comprise two or more compartments containing materials therein with a breakable divider, such that when the divider is broken the materials mix and thermal effect is created. The internal lining member can further comprise an opening for the insertion of material to be administered to the patient through the skin, and/or a container for the material to be administered to the patient. The container can be connected to a port of the internal lining member. In another embodiment, the internal lining member container can comprises one or more compartments containing insulating material. When the rigid portions of the device comprise rigid members, the device can further comprise an actuator attached to one of the rigid members. The actuator can further comprise a motor spinning a disc and optionally two end bolts and a rod, one end bolt connecting eccentrically the disc and the rod and the other end bolt connecting one of the rigid members and the rod. Within the device, the motor spinning the disc can generate a motion of one or more body parts adjacent the joint of the user. The attachment member can comprise one or more straps and a fastening mechanism, the one or more straps are connected to one or more of the two or more rigid portions and comprises one or more parts of the fastening mechanism. The fastening mechanism can comprise one or more pairs of patches, wherein within each pair one patch comprises hooks and the other patch comprises loops. The fastening mechanism can be a buckle. The vibrating mechanism can be attached to the one or more wrapping members and can deliver vibrations to the joint of the user. Within the device, the vibrating mechanism can be attached to one or more of the two or more rigid members and deliver vibrations to the joint of the user. The joint can be a shoulder, an elbow, a wrist, an ankle, a knee, a jaw bone. The location in the body can be a palm. The device can further comprise a footrest made of rigid or semi-rigid material; a pivot connected to the footrest; and one or more wheels connected to the pivot. The device can further comprise a sensor for vibrations, the sensor providing an indication of the presence or absence or intensity of vibrations in a second location in the body. The device can further comprise a mechanism for adjusting the vibrating mechanism activity according to the indication of the sensor. The device can fixate the joint, or can enable movement of the joint. The device can further comprise, or connect to a sensor for measuring a body parameter, such that measurements taken from the sensor, such as ECG, EEG, blood pressure, temperature, heart rate, SpO2 levels, blood flow, tissue perfusion or any other body parameter can be used to control the vibrations by changing their characteristics, stopping, or starting them. One can also measure the vibrations in different body organs resulting from the device and adjust the activity of the device accordingly.

Another aspect of the present invention shows a method for introducing intermittent vibration to a joint of a user, the method comprising the steps of introducing one or more wrapping members to two or more body parts adjacent the joint; attaching the one or more wrapping members to the two or more body parts adjacent to the joint through attaching one or more attachment members to the one or more wrapping members and the two or more body parts adjacent the joint; and introducing vibrations to the joint adjacent the two body parts to which the one or more wrapping members are attached. The one or more wrapping members can be a flexible member substantially fitting the area adjacent the joint, or the one or more wrapping members can comprise two or more rigid portions. Within the method, the two or more rigid portions can be two or more rigid members. Within the method, the vibrations can be introduced intermittently, or a according to a protocol. The protocol can be preset, and can determine the times, duration, frequency and amplitude of the introduced vibrations. The method can further comprise a step of fixating the joint, or allowing the joint to move in predetermined directions within predetermined ranges. The movement can require effort or no effort from the patient from the patient. Alternatively, the method can comprise the step of moving one or more rigid portions in a predetermined direction by a predetermined range. The method can comprise a step of pressing and releasing, or heating or cooling a body portion adjacent to the joint, or the location in the body. Within the method, the vibrations can be delivered to the location in the body through a lining, which is optionally filled with liquid. The method can further comprise a step of administering material to the location in the body, or filling the lining with the material to be administered. The method optionally comprises a step of measuring the presence or absence or intensity of vibrations in another location in the body, and adjusting the introduced vibrations according to the presence or absence or intensity of vibrations in the other location in the body. The adjustment can be performed automatically or manually.

### BRIEF DESCRIPTION OF THE DRAWINGS

The present invention will be understood and appreciated more fully from the following detailed description taken in conjunction with the drawings in which:

FIG. 1 is an illustration of a the hand and back of a person wearing an elbow device, in accordance with the preferred embodiment of the invention;

FIG. 2 is an illustration of the rigid portions and straps of the elbow device, in accordance with the preferred embodiment of the invention;

FIG. 3 is an illustration of the rigid portions and straps of the joint-moving elbow device, in accordance with the preferred embodiment of the invention;

FIG. 4 is an illustration of the internal lining of the elbow device, in accordance with the preferred embodiment of the invention;

FIG. 5 is an illustration of a hand and shoulder of a person wearing a joint-moving elbow device, in accordance with the preferred embodiment of the invention;

FIG. 6 is an illustration of the vibrating mechanism, in accordance with the preferred embodiment of the invention;

FIG. 7 is an illustration of the vibrating assembly within the vibrating mechanism; inside a housing, in accordance with the preferred embodiment of the invention;

FIG. 8 is a top view of an exemplary lining of the proposed devices, in accordance with the preferred embodiments of the invention;

FIG. 9 is an illustration of a knee wearing a knee joint-moving device with a schematic view of the joint-moving mechanism, in accordance with a preferred embodiment of the invention;

FIG. 10 is an illustration of a knee wearing a knee joint-moving device and a schematic view of another joint-moving mechanism, in accordance with a preferred embodiment of the invention;

FIG. 11 is an illustration of the leg of a person wearing a knee device, in accordance with a preferred embodiment of the invention;

FIG. 12 is an illustration of the rigid portions and straps of the knee device, in accordance with a preferred embodiment of the invention;

FIG. 13 is an illustration of the rigid portions and straps of the joint-moving knee device, in accordance with a preferred embodiment of the invention;

FIG. 14 is an illustration of the internal lining of the knee device, in accordance with a preferred embodiment of the invention;

FIG. 15 is an illustration view of the leg of a person wearing a joint-moving knee device, in accordance with a preferred embodiment of the invention;

FIGS. 16A and 16B are illustrations of two states of a device for moving the knee joint, in accordance with a preferred embodiment of the invention;

FIG. 17 is an illustration of a device for moving the foot forward and backwards and thus moving the knee, in accordance with a preferred embodiment of the invention;

FIG. 18 is an illustration of the device of FIG. 17 with a leg of a person wearing the joint-moving knee device, in accordance with a preferred embodiment of the invention;

FIG. 19 is an illustration of the rigid portions, straps and lining of the palm device, in accordance with a preferred embodiment of the invention;

FIG. 20 is an illustration from above of a hand wearing the palm device of FIG. 19, in accordance with a preferred embodiment of the invention;

FIG. 21 is an illustration from below of a hand wearing the palm device of FIG. 19, in accordance with a preferred embodiment of the invention;

FIG. 22 is an illustration of the rigid portions and straps of a wrist and palm treatment device, in accordance with a preferred embodiment of the invention;

FIG. 23 is an illustration of the lining of the wrist and palm device, in accordance with a preferred embodiment of the invention;

FIG. 24 is a top view illustration of a hand wearing the wrist and palm device, in accordance with a preferred embodiment of the invention;

FIG. 25 is a bottom view illustration of a hand wearing the wrist and palm treatment device, in accordance with a preferred embodiment of the invention;

FIG. 26 is an illustration of the rigid portions and straps of a joint-moving wrist and palm treatment device, in accordance with a preferred embodiment of the invention;

FIG. 27 is an illustration of a hand wearing the joint-moving wrist and palm treatment device, together with the joint-moving directions, in accordance with a preferred embodiment of the invention;

FIG. 28 is a bottom view illustration of a hand wearing the joint-moving wrist and palm treatment device, in accordance with a preferred embodiment of the invention;

FIG. 29 is a schematic illustration of a mechanism for moving the wrist the palm and the finger joints, in accordance with a preferred embodiment of the invention;

FIG. 30 is an illustration of a foot and ankle of a person wearing an ankle and foot device, in accordance with a preferred embodiment of the invention;

FIG. 31 is an illustration of the rigid portions and straps of the ankle and foot device, in accordance with a preferred embodiment of the invention;

FIG. 32 is an illustration of the rigid portions and straps of the joint-moving ankle and foot device, in accordance with a preferred embodiment of the invention;

FIG. 33 is an illustration of the internal lining of the ankle and foot device, in accordance with a preferred embodiment of the invention;

FIG. 34 is an illustration of a foot and ankle of a person wearing a joint-moving ankle and foot device, in accordance with a preferred embodiment of the invention;

FIG. 35 is an illustration of the rigid portions of a shoulder treatment device, in accordance with a preferred embodiment of the invention;

FIG. 36 is an illustration of the internal lining of a shoulder treatment device, in accordance with a preferred embodiment of the invention;

FIG. 37 is an illustration of a person wearing the shoulder treatment device, from behind, in accordance with a preferred embodiment of the invention;

FIG. 38 is an illustration of a person wearing the joint-moving shoulder treatment device, from the side, in accordance with a preferred embodiment of the invention;

FIG. 39 is a schematic illustration of a mechanism for moving the shoulder, in accordance with a preferred embodiment of the invention;

FIG. 40 is an illustration of a foot and ankle of a person wearing an ankle and foot flexible device, in accordance with a preferred embodiment of the invention;

FIG. 41 is an illustration of a knee of a person wearing a flexible knee device, in accordance with a preferred embodiment of the invention;

FIG. 42 is an illustration of a knee of a person wearing a flexible knee device with straps, in accordance with a preferred embodiment of the invention; and

FIG. 43 is an illustration of a knee of a person wearing another knee flexible device with straps, in accordance with a preferred embodiment of the invention.

### DETAILED DESCRIPTION OF THE PREFERRED EMBODIMENT

This application claims priority from Israeli patent application serial number 166468 titled “DEVICES AND METHOD FOR APPLYING VIBRATIONS TO JOINTS” filed Jan. 24, 2005, and from Israeli patent application serial number 168520 titled “DEVICES AND METHOD FOR APPLYING VIBRATIONS TO JOINTS” files May 10, 2005, both applications are incorporated herein by reference.

The present invention overcomes the disadvantages of the prior art by providing novel devices and a method for delivering vibrations to body parts, such as joints or other locations in the body of patients suffering from arthritis and other chronic joint symptoms.

The present invention provides devices and a method of introducing vibrations to a location in the body, for example a joint and the joint area of a person suffering from arthritis. Optionally, the joint is in a relaxed position when the method is applied. The vibrations are intermittent, and are introduced according to protocols determining the start times of the vibration sessions, the length of each vibration session, the amplitude, and the frequency of the vibrations.

A number of devices are disclosed that implement the method of introducing vibrations to locations in the body or to user's joints. Each device is specifically designed to introduce vibrations to, or in the area adjacent a certain joint of the body. Each device comprises one or more rigid parts, said parts are made of materials such as plastic, acrylic, polyurethane, metal or the like, and flexible members such as straps. The rigid parts of the device are designed to support a vibrating device to the relevant location in the body, i.e., the joint or area adjacent the joint. Flexible members such as straps are used for attaching the rigid parts of the device to the body area of the user. Each device further comprises a vibration generating mechanism, which generates knocking vibrations and vibrates the rigid parts of the device and hence the relevant body part. In the preferred embodiment of the present invention, the disclosed device can further comprise, an internal lining member, for purposes such as padding, heating, cooling the relevant body region, releasing, and transferring various transdermal medications and others. The lining can further increase the effect of the vibrations and aid in evenly distributing the vibrations. In a preferred embodiment of the invention, each device can fixate the relevant joint in a relaxed non-strenuous condition. Alternatively, the device allows the joint a limited movement in predetermined directions and ranges. In yet another embodiment, the device moves the joint in a predetermined direction and range, thus enhancing the device's effectiveness. Moving the joint while vibrating it contributes to improved muscle power, increased joint range of motion, increased circulation and improved joint function.

Alternatively, the devices comprise one or more flexible members instead of the rigid parts. The flexible members are designed to fit and stretch around a location in the body such as the joint and its adjacent area. The flexible members preferably comprise an opening, loose, i.e., excess or slack material, or another characteristic that enables the adjustment to the joint and the movement, i.e., the flexing and relaxing of the joint when the device is used. For example, a device designed for the elbow can comprise an opening in the flexible member, through which the protruding part of the joint, in this case the olecranon, protrudes when the joint is flexed. At the side of the joint opposite the protruding part, the flexible member, the device optionally comprises stitches, additional (extra) material or yet another feature to enable the user comfortable movement of the joint by allowing for spanning of the flexible member.

Specific devices are disclosed for the elbow, knee, palm, wrist, ankle, and shoulder. However, the vibrations are transferred by the bones and other body tissues such as muscles tendons and ligaments, so that further joints are vibrated as well. For example, the device designed for the knee provides vibrations also to the hip joint, and the device designed for the shoulder provides vibrations to the spinal column. Persons skilled in the art will appreciate that like devices designed to deliver vibrations to other joints in like manner are covered by the present invention.

In the context of the disclosed invention, the term joint refers not only to bones, cartilage and the synovial space, but to all elements and tissues in the surrounding areas or that connect to the bones or to the surrounding areas. In addition to the bone, these includes but are not limited to, the connecting tissues, the muscles affecting the bones, the tendons at the ends of the bones, the nerves that activate the muscles and the sensory system (such as pain, contact, spatial sensation, and temperature), the blood and lymph vessels, the synovial, the synovial fluid, and the skin. The connective tissues relate to any type, such as fibrous connective tissue forming ligaments and tendons which hold the bones and affect its movement, or cartilaginous connective tissue which forms cartilage. The blood vessels relates to arteries, veins or capillaries. The embodiments of the disclosed invention are constructed and used such that they introduce simultaneous vibrations to all parts of a joint and not only the bones, thus providing a healing effect to multiple conditions, problems, or limitations associated with arthritis or other musculoskeletal disorders, relating to any of the elements or tissues, whether the problem is osteoporosis, over use syndromes, ligament shortening due to arthritis, or inability to move the joint for a period of time such as after surgery. Additional effects such as bone building after fracture and potentially even cartilage building are also achieved.

As will be demonstrated in association with specific embodiments discussed below, since the device contacts the joint at continuous multiple areas, the vibrations are transported to every part of the joint from multiple directions, along multiple vectors, thus preserving the amplitude and frequency and amplifying the effects of the vibrations. In contrast, the vibrations generated by known devices, which contact the joint only at discrete points, are sometimes applied only from one bone connected to the joint, thus reaching the joint only from one direction, and are transported solely through the bones, thus the vibrations' amplitude and frequency gets attenuated, which results in reduced effectiveness.

The effectiveness of all disclosed embodiments is further enhanced by an efficient grip applied by the device at those areas of the bones connected at the joint, which are close but not at the immediate area of the joint. The typical distance between a joint and the area of a bone wherein the grip is the most efficient is between 2 cm and 15 cm, depending on the joint and the specific structure of the device. Although the grip is efficient it does not cause pain or other discomfort at the gripped areas. By the grip being mainly farther from the joint, the joint itself is supported but no pressure is applied to it. Thus pressure, pain, and other discomforts are eliminated from the sick tissues, and the joint is allowed to move without additional limitations or difficulties to its inherent problems. This grip, which eliminates pressure and motion limitation from the joint enables applying vibrations to the joint, either when the joint is static at a neutral anatomic position, or during continuous passive motion (CPM), as applied by some embodiments of the disclosed devices detailed below. Patients suffering from joints, skeletal, or neurological diseases tend to suffer from morphological or positional changes in the joint, caused by changes in the bones, muscles, tendons or cartilage tissues, as well as by pain or neurological disturbances, muscular atrophy. Whether the changes are congenital, due to illness, accident or any other cause, the abovementioned gripping scheme, which avoids tight grip or pressure of the joint itself, makes the devices applicable also to distorted or deformed joints.

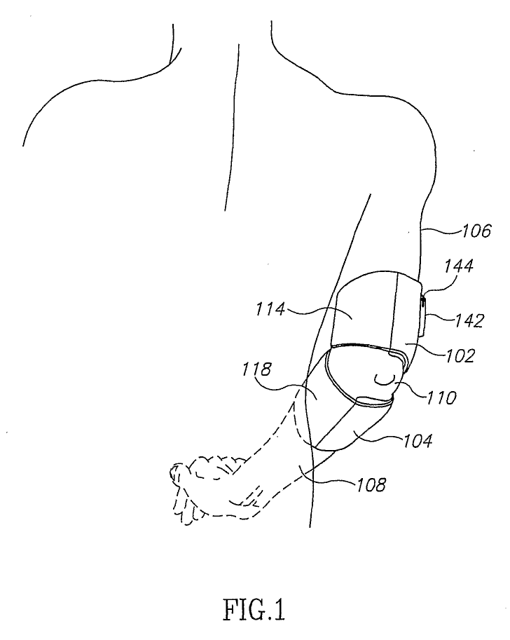

Reference is now made to FIGS. 1, 2, 3, 4, and 5, describing a device designed for treating an elbow, in accordance with the preferred embodiment of the present invention.

Referring now to FIG. 1, there is illustrated a rear view of a user wearing a device designed for the elbow, from the dorsal area of the device. The device comprises rigid portions 102 and 104 of the device are supporting respectively the user's upper arm 106 and forearm 108, thus surrounding the user's elbow 110. An upper strap 114 and a lower strap 118 wrap the upper arm 106 and the lower arm 108, respectively, and attach rigid portions 102 and 104 to the body of the user. A vibrating mechanism 142 equipped with an on/off switch 144 is attached to rigid portion 102. In operation the vibrating mechanism delivers vibration to the limb of the patient, said vibrations travel to the joint 110 through the rigid members 102, 104.

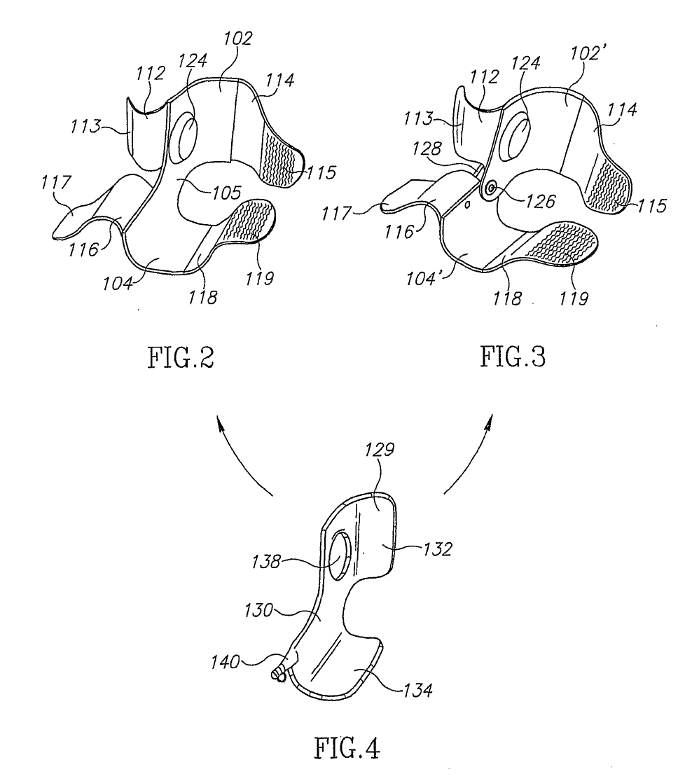

Referring now to FIG. 2 showing an illustration of a joint fixating embodiment of the elbow device of FIG. 1, in accordance with a preferred embodiment of the present invention. The elbow device comprises a brace having an upper rigid portion 102, a lower rigid portion 104 and a connecting portion 105 preferably made of a single piece. The elbow device further comprises straps 112, 114, 116, 118 designed to attach the device to the upper arm and forearm of the user. In one embodiment of the present invention, the single piece brace is preferably having a substantially elongated curved rectangular shape, having a curvature to fit said arm and forearm, and a c-shaped opening adjacent to portion 105 to fit the elbow of the user, adjacent the joint of the user. In the preferred embodiment, the upper rigid portion 102 and the lower rigid portion 104 are positioned such that a fixed angle is formed between the arm and the forearm of the user wearing the device. The fixed angle, created between the limbs of the user, is preferably an angle of between about 20 degrees and about 190 degrees. Straps 112 and 114 are connected to upper rigid portion 102 and end respectively with portions 113 and 115, carrying fastening elements such as VELCRO pieces, multiple usage adhesive patches, magnetic mechanism, laces, or the like. When the device is worn, straps 112 and 114 wrap the upper arm of the person wearing the device, and the fastening element of portions 113 and 115 are fastened to each other over the front portion of the upper arm. Analogously, straps 116 and 118 are connected to lower rigid portion 104, and end with portions 117 and 119 carrying fastening element. When the device is worn, straps 116 and 118 wrap and hold the forearm of the person wearing the device, and the fastening elements of portions 117 and 119 are fastened to each other over the front portion of the upper arm. Straps 112, 114, 116 and 118, and portions 113, 115, 117 and 119, carrying the fastening elements can be made of the same material as rigid portions 102 and 104, but processed to be thinner so as to achieve flexibility and enable them to wrap around the upper arm and the forearm. Alternatively, straps 112, 114, 116, 118 and portions 113, 115, 117 and 119 can be made of any flexible material, such as elastic fabric, rubber, flexible polymer or the like. An opening 124, which can be a round opening in upper rigid portion 102 is intended to accommodate the vibrating mechanism. Opening 124 adapted to receive the vibrating mechanism, can be of any required shape, for example rectangular, square, or irregular shape, and can be located anywhere on the device, and is not limited to the shown shape and location. Alternatively, there can be no opening in the rigid parts of the device. In this case, the vibratory mechanism is externally attached to any of the rigid parts. In accordance to one preferred embodiment, the single piece brace can be manufactured through the process of injecting a polymer into a mold having the shape substantially of the arm of the user. In other alternatives the single brace can be manufactured from other sturdy materials such as acrylic, plastic, hardened rubber, metal, wood, pulp, cardboard and any like other rigid materials. In another preferred embodiment the single piece brace and the straps can be molded together from the same material, said material having rigid and semi-rigid properties.

Referring now to FIG. 3, showing another preferred embodiment of the elbow device of the present invention. The device comprises an elbow brace, comprising an upper rigid member 102′ and a lower rigid member 104′, connected to each other by a pivot such as a hinge 126, or another connecting mechanism. Upper member 102′ and lower member 104′ are substantially rectangular and curved to fit the arm and the forearm of the user. Pivot 126 attaches members 102; and 104′ to each other in a fixed position, thus fixating the elbow of a user wearing the device in a predetermined fixed angle, preferably between about 20 degrees and about 190 degrees. Alternatively, pivot 126 enables a relative movement between member 102′ and member 104′, thus the angle of the elbow of the user is changeable. The angle can be changed freely or in a predetermined range. In one embodiment of the present invention, the angle between member 102′ and member 104′ can be changed by the user of the device by setting the position of said members and using the pivot 126 and a latch or a lock (not shown) to fixate said angle as required. Members 102′, 104′ may also be connectable to one another with alternative attaching elements easily detachable, such as a bandage, belt, buckle, clasp, cleat, glue, hook, VELCRO, latch and lock, pins, wire, button, sew, stitch, staple, zipper or the like.

Similarly to shown in FIG. 2, straps 112, 114, 116 and 118 and portions 113, 115, 117, 119 are wrapped and fastened around the upper arm and the forearm of the user of the device. When using the device, members 102′ and 104′ can move relatively to each other, thus causing the contraction and extension of the elbow Alternatively, when the user extends or contracts the elbow, members 102′ and 104′ move relatively to each other. In an alternative embodiment, the device includes a mechanism for activating movement of upper rigid member 102′ and lower rigid member 104′ relatively to each other when the device is used. An exemplary mechanism for moving rigid members 102′ and 104′ and hence the arm and forearm of the user relatively to each other is described in association with the figures below.

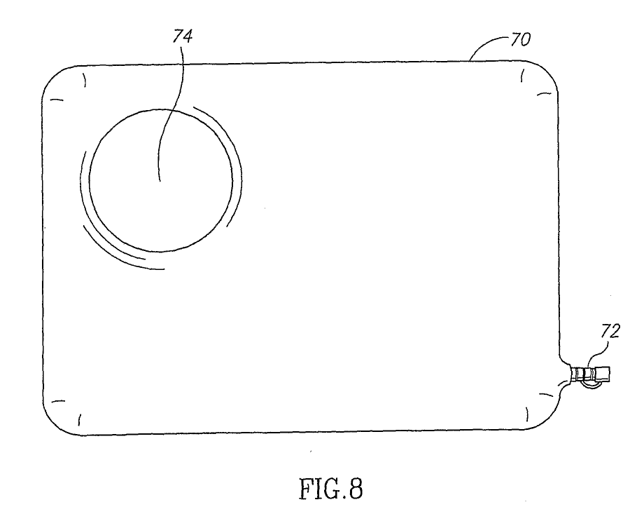

Referring now to FIG. 4, showing the internal lining of the elbow devices, generally referenced 129. The properties and options related to the lining 129 are described in detail in association with FIG. 8 below. The structure of lining 129 is designed to fit the rigid portions or members of the elbow braces, as shown in FIGS. 2, 3. A main portion 130, an upper flap 132 and a lower flap 134 fit the region of pivot 126 of FIG. 3, upper rigid member 102′ and lower rigid member 104′ or the brace of FIG. 2. An opening 138 is designed to overlap opening 124 in the upper rigid portion 102 or member 102′. The vibrations generating mechanism (not shown) is inserted into opening 124 and 138. An inlet 140 is used for filling internal lining 129 with the relevant substance, in case the lining is of a refillable type. In the preferred embodiment of the present invention, the lining is filled with fluid to better accommodate the lining to the shape of the limb of the user of the device of the present invention. The lining can be filled prior or after the user has mounted the device on the limb to receive vibrations.

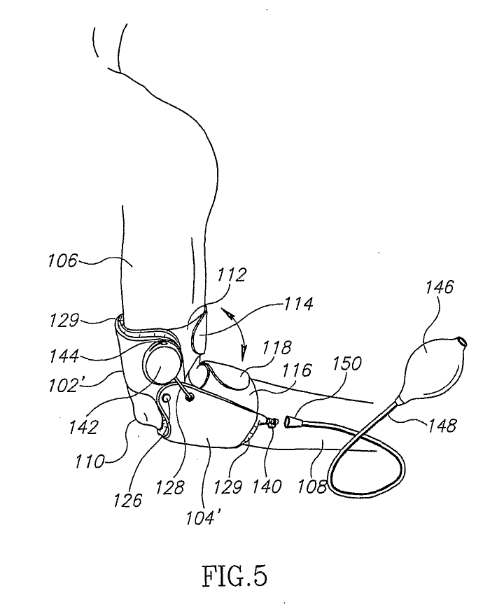

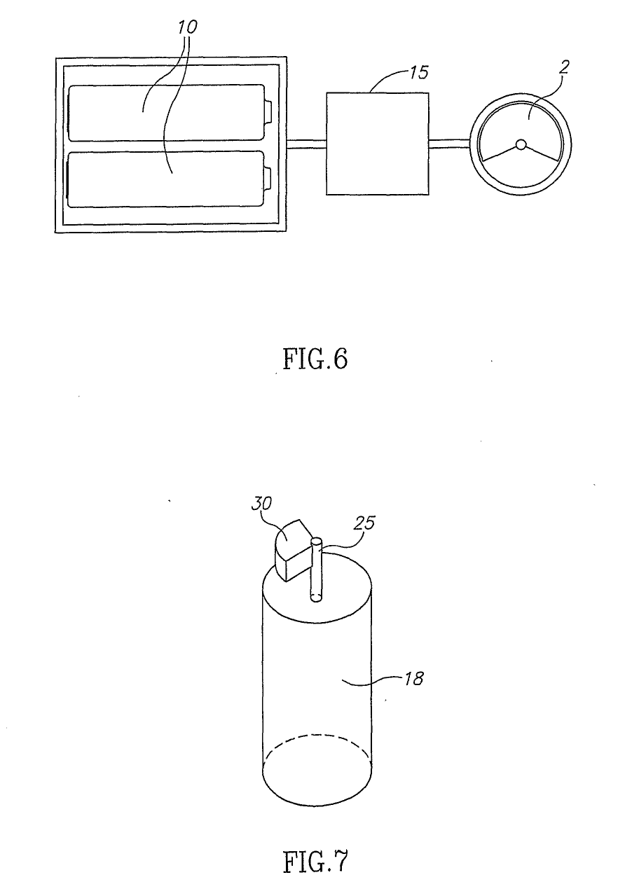

FIG. 5 shows a side view of the hand and shoulder of a user wearing the elbow device shown in FIG. 3. As in FIG. 1, rigid members 102′ and 104′ support the user's upper arm 106 and arm 108, around the user's elbow 110. Straps 112 and 114 are wrapped around the upper arm, straps 116 and 118 are wrapped around the forearm, and lining 129 rests between rigid members 102′, 104′ and the skin of the user or the clothes thereon. If the lining is of a type that is inflated by air, a manual pump 146, connects through a tube 148 and a plug 150 to opening 140 in lining 129. Alternatively, an electrical pump can be provided instead of the manual pump 146. If opening 138 in lining 129 of FIG. 4, and opening 124 in rigid member 102′ of FIG. 3, or opening 124 in rigid member 102′ of FIG. 2 is present, housing 142 of the vibratory mechanism resides inside said opening. Alternatively, housing 142 is attached to any of the rigid parts of the device. Housing 142 can be applied to the rigid parts of the device using any attaching element to fixedly secure the housing 142 to the device while applying vibrations. The structure and functionality of the vibratory mechanism are described in detail below in association with FIGS. 6 and 7. In an alternative embodiment, housing 142 further comprises a mechanism for moving the rod 128, thus allowing to control the movement of the forearm relative to the upper arm. Alternatively, rod 128 can be used to adjust the position or to fixedly secure the joint of the user in a predetermined position or positions, also at any time during the application of the vibrations by the device. A variety of mechanisms can be employed for moving the elbow, exemplary mechanisms are described further below.

As shown in FIG. 1 and FIG. 5, the disclosed elbow devices grip the bones rather than the joint itself. Since the devices wrap the elbow from its two directions, and since wide parts of the arms come in contact with the vibrating device, rather than vibrating only at discrete points, the vibrations are applied to all parts of the elbow, and along multiple vectors, thus enhancing the effectiveness of the vibrations.

The elbow itself is not gripped, while the arm bones are gripped not at immediate proximity to the elbow, but rather at areas distant between about 2 cm about 20 cm from the elbow. This gripping eliminates pressure or pain from the elbow itself, and allows it to be in neutral anatomic position or to be responsive to continuous passive motion. Even if the elbow is distorted due to age, sickness, accident or the like, the device can be used without further changes, since it is not limited by the elbow's structure.

Referring now to FIG. 6, showing a schematic block diagram of a preferred embodiment of a vibrating mechanism. The vibrating mechanism is attached to any rigid or soft part of any of the described joint-treating devices, thus vibrating the device and the relevant body part and joint. The vibrating mechanism is enclosed in a housing, such as housing 142 of the elbow device. The vibrating mechanism comprises a power source 10, a controller 15 and a vibrating assembly 20. Power source 10 is preferably a battery. Alternatively, power source 10 is an external power source, a portable power supply such as a small rechargeable or non-rechargeable battery, a mechanical energy source, such as a charged spring, a fuel cell, a magnetic or electrical power source, other electrochemical power sources, solar panels, and the like. Controller 15 can be an industrial of-the-shelf control circuit that activates and deactivates vibrating assembly 20 according to a predetermined protocol. In the preferred embodiment of the present invention the controller 15 activates and deactivates the vibrating assembly so as to provide intermittent vibration to the joint of the user. The electronic circuit is, for example comprised of a timing circuit, which controls when the motor switches on and off and the speed of the motor, and a Field Effect Transistor (FET) to power the motor itself. In an alternative embodiment, controller 15 further comprises a LED indicator (not shown) and an audio indicator such as a buzzer (not shown) providing audio or visual indication or alerts to the user. The timing circuit in a preferred embodiment is based on a PIC16LF873A chip.

In another embodiment of the present invention, in addition to the intermittent vibration of the vibrating assembly, controller 15 activates and deactivates the vibrating assembly according to an activation protocol that providing for various activation times, durations of operation, frequency, and amplitude of the vibrating assembly. In a preferred embodiment, the times and durations of the protocol can be described in terms of seconds, minutes, hours, days or weeks. An exemplary protocol is “activate the mechanism for 20 seconds every minute for 30 minutes, and repeat the above every 6 hours for 3 days”. The activation protocol is predetermined and is programmed into the industrial control circuit. Alternatively, the industrial control circuit can be programmed by medical personnel or skilled technician according to a physician's instructions.

FIG. 7 depicts a schematic illustration of a preferred embodiment of vibrating assembly 20 of FIG. 6. The vibrating assembly comprises an actuator, such as electrical, magnetic or electromagnetic motor 18, a shaft 25, and an eccentric weight 30. Actuator 18 can also comprise other energy delivering mechanism to deliver energy to shaft 25 thereby rotating said shaft on its axis or causing a hammer like device to repeatedly hit a surface. Other energy delivering mechanism can further comprise other knocking vibration generators such as hammering that involves rotating and non rotating engines. When actuator 18 rotates, shaft 25 which is concentric with motor 18 rotates as well, thus rotating weight 30, which is eccentrically mounted on shaft 25. When rotating about shaft 25, weight 30 creates a vibration in rotation since it is shaped as a sector of a cycle and is eccentric with said shaft 25. The vibration is transferred to the device to which the vibrating assembly is attached thereto. In the disclosed invention, the vibrations are transferred to the rigid parts of the joint devices, to the lining and to the relevant joint and body parts. In addition, the vibrations are further transported to other body parts. Preferably, motor 18 is activated in frequency range of about 0.5 Hz to about 500 Hz. The abovementioned frequencies are within the range considered safe for joints.

Additionally, in accordance with the preferred embodiment of the present invention, the vibrations are introduced when the joint is not extended, contracted or strained, so the effect of the vibrations is beneficial pleasant and relaxing. The vibrations increase blood flow and tissue perfusion to the region of the joint, which helps in removing inflammatory factors and rehabilitation by the prevention of dysfunction. The delivery of directed vibrations through predetermined protocols at predetermined frequencies and amplitude also has an analgesic effect, build up muscle power, contributes to joint stability and assists in maintaining the health of the cartilage and expand the range of motion available to the user of the device. Referring now to FIG. 8, showing the general structure and characteristics of the internal lining of a joint device. Since FIG. 8 is intended for explaining the concepts relating to the internal lining in general, the lining shown in FIG. 8 is not adjusted for a specific joint, although persons skilled in the art will appreciate that the lining can be fitted to any joint. The internal lining member, generally referenced as 70 is preferably made of impermeable material and has an inner volume for containing material. The lining preferably comprises a back wall (not shown) and a front wall connected along the edges of said walls resulting in a pillow like lining having a cavity there within to be filled by a material. The material is preferably soft fabric, gel or fluid, such as water, air or lubricant for better adjusting the devices to the joint region. The lining can be permanently filled with the material, or it can be filled by a user prior to wearing a device and emptied afterwards. Alternatively, the lining can be filled by the user after wearing the device, for further adjustment and attachment of the device to the body. When the lining is to be filled by a user, it is equipped with a port 72 that facilitates the filling and draining. The port can be a one or two way port. The port can be equipped with a valve (not shown) for allowing the filling and draining of the lining. In case the device is to be filled with air, the device can further include a hand held pump that connects to port 72 in the lining or with an internal pumping/inflating mechanism. The lining can be disposable and pre-filled before use. The disposable lining can be pre-filled with a temperature conducting or temperature accumulating material. The filling gel or fluid make the device more comfortable and pleasant to wear on one hand, and more effective on the other hand, since the vibrations are transported through the material and spread evenly over all regions that come in contact with the lining. In another preferred embodiment, the lining and the material contained therein can be heated, for example in a microwave oven, or chilled in a refrigerator or a freezer. Alternatively the device comes equipped with a gas container (not shown) that connects to the lining, in order to chill the contents of the lining. In yet another preferred embodiment, the lining comprises two compartments with a breakable divider. Each of the two compartments is filled with a different material and when the divider breaks, the two materials mix and a thermal effect (i.e., heating or chilling) is created. This embodiment is especially useful for travel, when no equipment for heating or chilling is available. In another preferred embodiment, the internal lining or regions there of, such as the region that is in contact with the user's skin or the user's clothes, can be made of permeable material. The lining can then be charged with material that should be administered to the patient through the skin, such as medication, ointment, crème, liquid, or oil. The vibrations of the device massage the material contained in the lining into the skin of the user. In this embodiment, port 72 of the lining is preferably designed to connect to a tube containing the material. In yet another preferred embodiment, two or more of the abovementioned options are used in one embodiment, such as a lining that comprises one or more impermeable compartments filled with fluid, which is heated prior to the usage, and an additional compartments for a material that should be administered to the user. When using this combination, the heat may increase the absorption of the material by the skin and contribute to the effectiveness of the treatment. In yet another preferred embodiment, the lining can be made of washable or disposable materials. Optionally, the internal lining contains an opening 74, which is fitted in size and location to the opening in any of the rigid portions or elements of a device, such as opening 124 of FIG. 3. The opening 74 in the lining and in the rigid parts are designed to be congruent and supply a secure placement of the vibratory mechanism within the device. Alternatively, there is no opening in the lining, and the lining transforms the vibrations but isolates the vibrating mechanism from the skin. In yet another embodiment, there is an opening in the lining, but the side of the lining that is in contact with the user's skin or clothes is supplemented with a layer at the region of the opening 74, so as to isolate the user's skin from the vibrating mechanism.

Alternatively, a piezoelectric, or electro active polymer (EAP) actuator can be used as a vibrating mechanism. A piezoelectric, or EAP actuator typically comprises one or more piezoelectric or EAP elements, and may also include an additional vibrating amplifying/transmission element, constructed such that when alternating current is passed through the piezoelectric or EAP elements, the piezoelectric or EAP elements, possibly with one or more of the vibrating elements vibrate in a frequency that is generally equal to the resonance frequency of the piezoelectric or EAP elements. Such piezoelectric actuator is described for example in U.S. Pat. No. 5,565,726 granted to Toda, or in U.S. Pat. No. 6,342,750 granted to Rudolf et al. The usage of a piezoelectric actuator enables the application of vibrations in ultrasonic frequencies to the joint and joint area of the user of the apparatus of the present invention. The application of ultrasonic pulses with predetermined parameters such as frequency and amplitude, has been determined to accelerate the healing of bones and other tissues.

However, other mechanisms for generating vibrations at a predetermined frequency or range of frequencies can be used as a vibration generating mechanism in the disclosed invention. The EAP's can, for example, be designed to vibrate in low frequencies as well as in high frequencies.

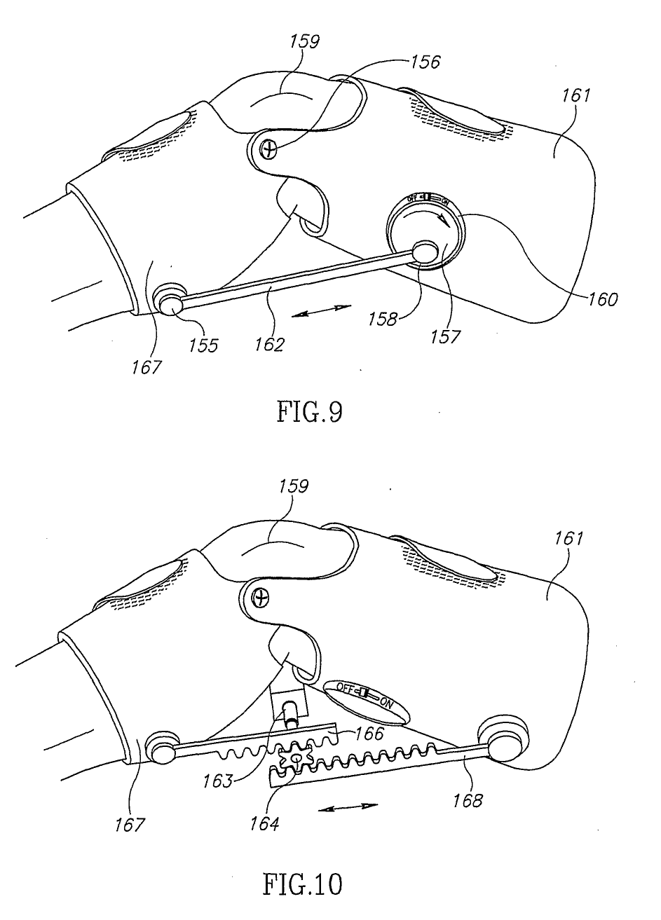

FIG. 9 and FIG. 10 show exemplary mechanisms for extending and contracting joints along one degree of freedom. The devices can be used for the elbow, knee, or ankle devices or others.

Referring now to FIG. 9, showing a device for a joint 159, comprising rigid members 161, 167, an actuator 160 and a rod 162. Rigid members 161, 167 are similar to the rigid members 102′, 104′ described in detail in association with FIG. 3. Actuator 160 is attached to rigid member 161 which supports a body part connected to joint 159. Actuator 160 preferably comprises a motor spinning a disc 157 connected to end bolt 158 of rod 162, said bolt is eccentrically connected to the disc 157. Rod 162 is further connected to rigid member 167 by means of end bolt 155 located distally to end bolt 158, attached to a second body part connected to joint 159. When motor 160 rotates, end bolt 158 of rod 162 connected eccentrically to disc 157 encircles the center of disc 157, thus extending and contracting joint 159.

Referring to FIG. 10, showing another preferred embodiment for moving mechanism for moving a joint 159. The mechanism is provided with rigid members 161, 167, a motor (not shown), a rotating shaft 163, two toothed combs 166, 168 and a tooth wheel 164 mounted on shaft 163. Rigid members 161, 167 are similar to the rigid members 102′, 104′ described in further detail in association with FIG. 3. When the motor rotates counter clockwise, tooth wheel 164 rotates counter clockwise, thus causing combs 166, 168 to shift horizontally and away from each other, and joint 159 to be extended. When the motor changes direction, tooth wheel 164 rotates clockwise and combs 166 and 168 shift towards each other, thus contracting joint 159. Therefore, if the motor is designed to alternate the rotation direction every predetermined interval, such as every 1 to about 30 seconds, joint 159 is alternately contracted and extended. In other preferred embodiment the time interval for rotation can be from a number of tenths of a second to a number of minutes. The presented exemplary mechanisms are also used for moving the knee or the ankle joints of a user wearing a device designed to treat the knee or the ankle. The motors and other parts of the disclosed mechanisms for moving a joint are preferably incorporated into the same housing as the vibratory mechanisms of the various disclosed devices. The joint-moving mechanisms are activated by the user's discretion, or according to the same protocols as the vibrating mechanisms, or according to different protocols.

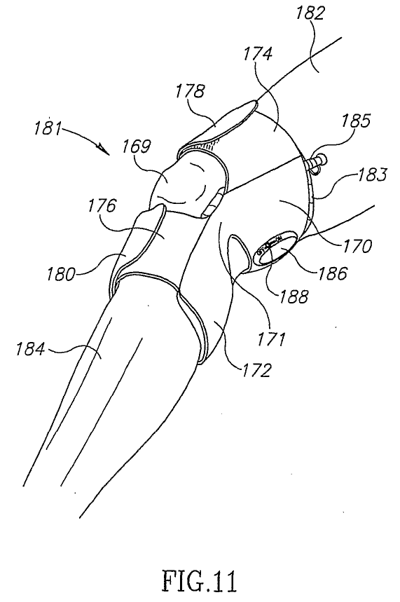

Reference is now made to FIGS. 11, 12, 13, 14, and 15, disclosing a device for treating arthritis and other chronic joint symptoms in a knee of a user, in accordance with another embodiment of the present invention. FIG. 11 shows a side view of a user wearing a fixating knee device around a knee 169, which is an adaptation of the elbow device of FIG. 2 to the knee. Rigid portions 170, 172, 171 are preferably made of a single piece and comprise a single piece brace to support respectively the user's thigh 182, shin 184, and the side of the knee 169. Upper straps 174 and 178 wrap the thigh, and lower straps 176 and 180 wrap the shin. In addition, an inflatable internal lining 183 is spread between rigid portions 170, 171, 172, and the user's skin or clothes, internal lining 183 is filled through an opening 185. A vibration motor housing 186 and an on/off switch 188 are located on upper rigid portion 170. In one embodiment of the present invention, the single piece brace is preferably having a substantially elongated rectangular shape, having a curvature to fit to said thigh and shin, and a c-shaped opening adjacent to portion 171 to fit the knee of the user. In the preferred embodiment, the upper rigid portion 170 and the lower rigid portion 172 are positioned such that a fixed angle is formed between the thigh and the shin of the user wearing the device. The fixed angle is preferably an angle of between about 20 degrees and about 190 degrees. As shown in the present figure the angle created by the single piece brace is about 120 degrees allowing the joint receiving the vibrations to be relaxed.

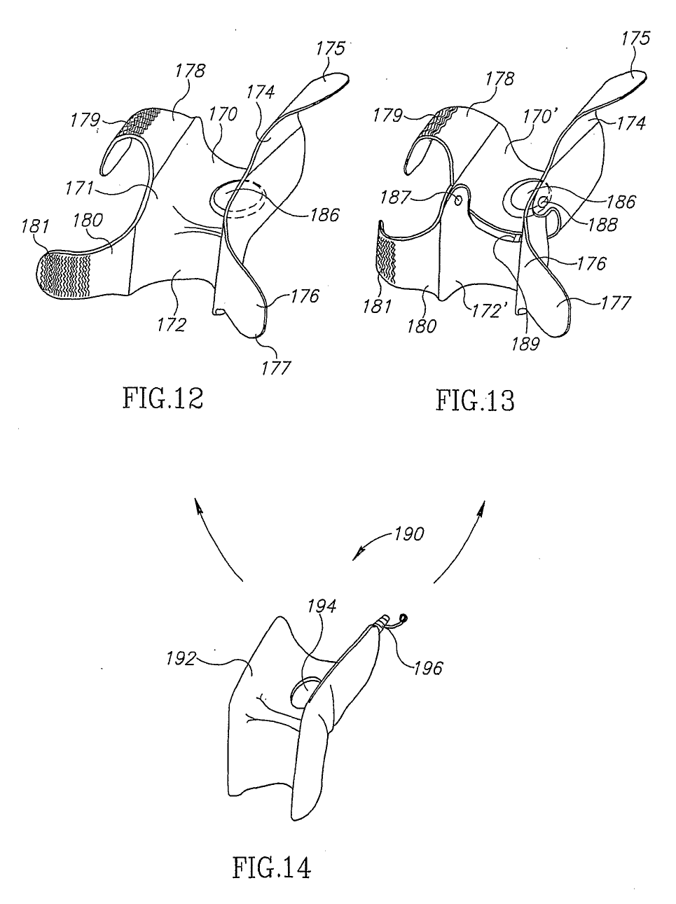

Referring now to FIG. 12 showing an illustration of a knee fixating embodiment of the knee device of FIG. 11, in accordance with another preferred embodiment. In a preferred embodiment, upper rigid portion 170 and lower rigid portion 172 are preferably made of one piece and are rigidly connected at a connecting portion 171. The member making up portion 170, 171, and 172 is made of a biocompatible sturdy material such as acrylic, plastic, hardened rubber and the like. Upper straps 174 and 178 are connected to upper rigid portion 170 and end respectively with portions 175 and 179, carrying fastening elements such as VELCRO pieces, multiple usage adhesive patches, magnetic mechanism, laces, or the like. When the device is worn, straps 174 and 178 wrap the thigh of the user of the device, and the fastening elements of portions 175, 179 are fastened to each other over the front portion of the thigh. Analogously, straps 176 and 180 are connected to lower rigid portion 172, and end with portions 177, 181 carrying fastening elements. When the device is worn, straps 176 and 180 wrap the shin of the person wearing the device, and the fastening elements of portions 177, 181 are fastened to each other over the front portion of the calf. Straps 174, 176, 178, 180, and portions 175, 177, 179, 181 carrying the fastening elements can be made of the same material as rigid portions 170, 171, 172, but flattened to achieve flexibility and enable them to wrap the thigh and the shin. Alternatively, straps 174, 176, 178, 180, and the portions 175, 177, 179, 181 can be made of another bio-compatible flexible material, such as elastic fabric, rubber or the like. A round opening 186 in upper rigid portion 170 is intended to accommodate the housing of a vibrating mechanism. Opening 186 can be of any required shape, for example rectangular, square, or amorphic shape, and can be located anywhere on the device, and is not limited to the shown shape and location.

Referring now to FIG. 13, showing another preferred embodiment for the knee device, which is an adaptation of the elbow device of FIG. 3 to the knee. As in FIG. 12, straps 174, 176, 178, and 180 and portions 175, 177, 179, and 181 are wrapped and fastened around the thigh and shin of a user. Unlike the device shown in FIG. 12, upper rigid member 170′ and lower rigid member 172′ are separate, and are connected to each other by pivots, such as hinges 187, 188 or any other connection mechanism that allows members 170′, 172′ to move relatively to each other. When using the device, members 170′, 172′ can move relatively to each other, thus causing the contraction and extension of the knee. Alternatively, when the user extends or contracts the knee, members 170′ and 172′ move relatively to each other. In an alternative embodiment, a rod 189 is a part of the mechanism that moves upper rigid member 170′ and lower rigid member 172′ relatively to each other when the device is used. As noted in association with FIG. 3 the pivots 187, 188 enable the fixating of the members 170′, 172 such that a fixed changeable angle is created there between.

Referring now to FIG. 14, showing an internal lining designed for the knee device, generally referenced as 190. The properties and options related to internal lining 190 were described in detail in the explanations relating to FIG. 8. The structure of internal lining 190 is designed to fit the rigid portions of the knee devices, as shown in FIG. 12 and FIG. 13. A main portion 192 fits connecting portion 171 of FIG. 12 or the portion of pivot 188 of FIG. 13, portions 170 and 172 of FIG. 12, or members 170′ and 172′ of FIG. 13. A round opening 194 is designed to be located congruently to opening 186 in upper rigid portion 170 or in member 170′. The vibrations actuator (not shown) is inserted into openings 186 and 194. A filling opening 196 uses for filling internal lining 190 with the relevant substance, in case the lining is of a refillable type.

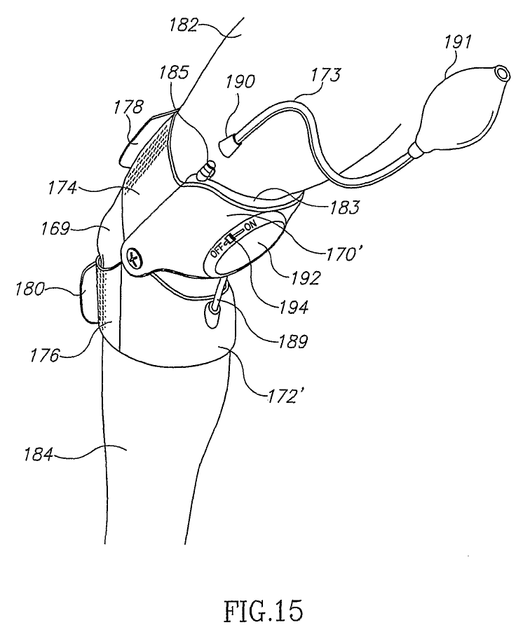

FIG. 15 shows a leg of a user wearing the knee device shown in FIG. 13. Rigid members 170′ and 172′ sustain the user's thigh 182 and shin 184, around the knee 169. Straps 174 and 178 are wrapped around the thigh, straps 176 and 180 are wrapped around the shin, and a lining 183 rests between rigid members 170′, 172′ and the skin of the person. If the lining is of a type that is inflated by air, a manual pump 186, connects through a tube 188 and a plug 190 to opening 185 in lining 183. A housing 192, enclosing a vibratory mechanism, is located inside a opening 194 in lining 190 of FIG. 14, and opening 186 in the rigid member 170′ of FIG. 12, if openings 194 and 186 exist. Alternatively, housing 192 is attached to any of the rigid parts of the knee device. The structure and functionality of the vibratory mechanism are as explained in association with FIGS. 6 and 7. Housing 192 further comprises an on/off switch 194 and a mechanism for extending and contracting the knee, which optionally employs a rod 189. A plurality of embodiments for the extending and contracting mechanism can be used, such as the abovementioned exemplary mechanisms shown and described above in FIG. 9 and FIG. 10. A better understanding of the changeable and fixed angles created by the design of the device can be appreciated from the view provided in FIG. 15 wherein the angle 188 between the members 170′, 172′ us shown on the lateral side of the device. Angle 188 can be changed by the movement of rod 189. In an alternative embodiment wherein rod 189 is not present, the angle 188 can be changed by the manual alteration of the position of pivot 187, which is shown as a screw able hinge, through the opening of the hinge and altering the position of members 170′ 172′ and are securing of said hinge into place.

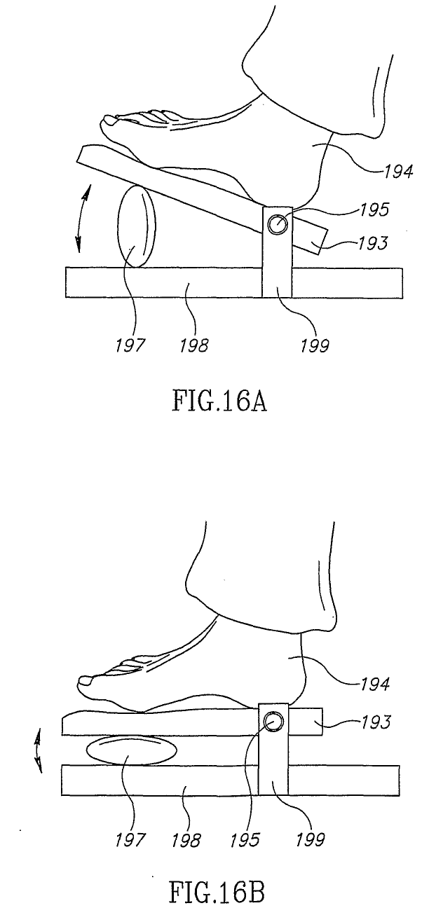

FIGS. 16A and 16B show a side view of another preferred embodiment of a mechanism for contracting and extending the knee. The user sets his or her foot 194 on a board 193, connected by a pivot 195 or another connection mechanism that enables the movement of board 193 relatively to two vertical boards 199 (only one shows). Vertical boards 199 connect to a second horizontal board 198. Located between boards 193 and 198, is a actuator (not shown) with a shaft (not shown) that connects to two parallel elliptic members 197 (only one shows). When the actuator rotates, so does the shaft, thus rotating elliptic members 197. When the main axis of elliptic members 197 is vertical, the user's foot rises, and the knee bends. When the main axis of elliptic members 197 is horizontal the user's foot is horizontal and the knee is extended. Similarly to other moving mechanisms, the shown mechanism can be operated simultaneously with the vibrating mechanism of the knee device, or according to different protocol, or at the user's discretion.

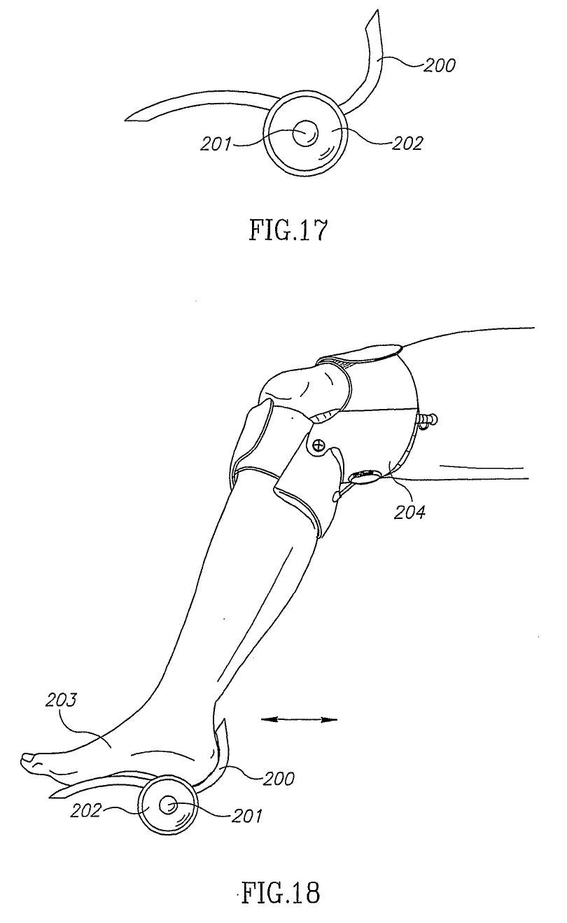

FIG. 17 shows a side view of an optional addition which comes with the knee device. The device comprises a sturdy footrest 220, the bottom of footrest 220 connected to a shaft 221 which in turn connects to two wheels 222. When the user the knee device with a mechanism for moving the knee, he or she can rest a foot 203 (of the same side as the treated knee) on footrest 220, and when the knee extends and contracts, foot 203 goes forward and backwards on the floor. This eliminates any effort on the side of the user due to the extending and contracting of the knee.

FIG. 18 show the leg of the user wearing the knee device 224, the user's foot 203 resting on footrest 220. When the knee extends, it moves forward effortlessly.

As explained for the elbow devices, the disclosed knee devices grip the bones rather than the knee itself, and the gripping is done over wide areas, the vibrations are applied to all parts of the knee, and along multiple vectors, thus enhancing the effectiveness of the vibrations. The structure also allows the knee to be in neutral anatomic position or to be responsive to continuous passive motion. The disclosed devices can be used even if the knee is distorted or deformed.

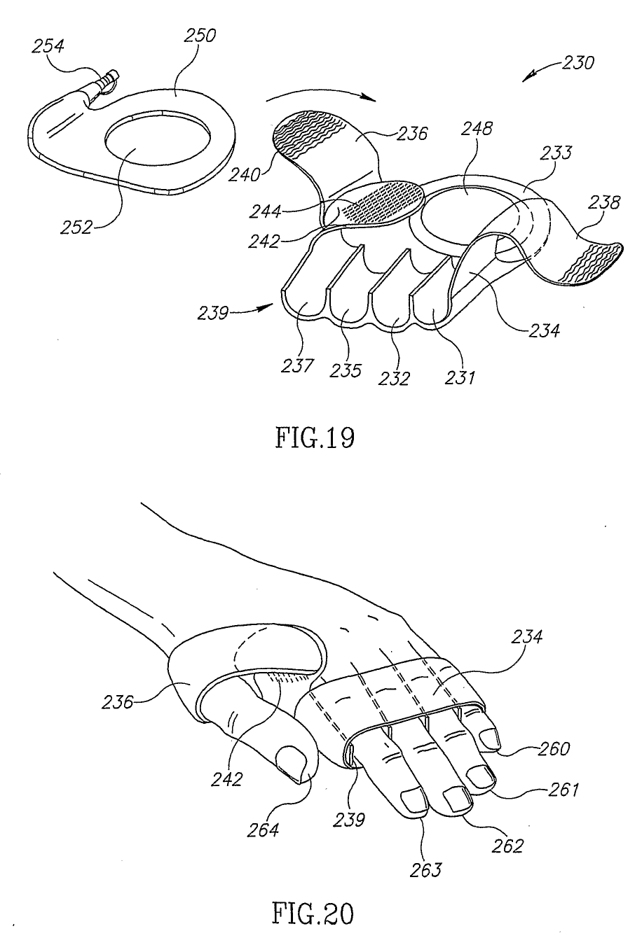

Referring now to FIGS. 19, 20, 21 disclosing a device for treating arthritis and other chronic joint symptoms in the palm of a user, in accordance with yet another embodiment of the present invention. The device, generally referenced 230, comprises a fingers holder element, generally referenced 239, containing four finger compartments 231, 232, 235, 237 for placing therein the fingers excluding the thumb, of a user. Fingers holder element 239 is connected to a support portion 233 on which the user's palm is to be placed. In one alternative embodiment, support portion 233 comprises an opening 248 for holding a vibrating mechanism. The device further comprises three straps, strap 234 having fastening elements, such as a VELCRO patch or any other attaching elements at its distal portion 238. When the device is worn, strap 234 is placed over the fingers and is attached at the forefinger, under portion 239. Strap 242 comprise an attachment carrying portion 244 at its distal end and is at length spanning the fingers portion to the back of the hand. Strap 236 having an attachment carrying portion 240 at its distal end encircles the thumb and is attached to portion 244 over the carpal and metacarpal bones. An internal lining, generally referenced as 250, is fitted between the device and the user's fingers excluding the thumb. In an alternative embodiment, an opening 252 in lining 250 is placed congruently with opening 248 of device 230. When internal lining 250 is of the type that is filled by a user, it may be filled via an opening 254, which can comprise a two-way tube having a closure for allowing inflation or deflation of the lining with liquid or other substance. The properties and options related to internal lining 250 are as described in detail in the explanations relating to FIG. 8.

FIG. 20 shows an illustration of a top view of the hand of a user wearing the palm device of FIG. 19. The user's fingers 260, 261, 262, and 263 are resting in compartments 231, 232, 235, and 237, respectively. Strap 234 is fastened around the fingers excluding the thumb, and under the forefinger; strap 236 is fastened to the upper section of strap 242. The disclosed device fixates the palm, so as to allow a firm and comfortable closure of the fingers within the fingers holder element 238 through the use of the overlapping straps 234, 236 and does not enable any joint in the palm to move when the device is used.

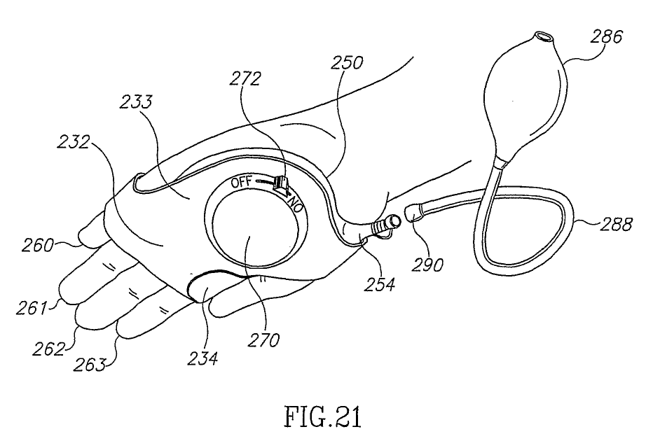

Referring now to FIG. 21, showing a bottom view of a left hand of a user wearing the palm device of FIG. 20. Fingers 260, 261, 262 and 263 rest in fingers holder element 238 of FIG. 20, the palm rests on palm portion 233, lining 250 is fitted between support portion 233 of the device and the palm of the user. If lining 250 is of a type that is inflated by air, a manual pump 286, connects through a tube 288 and a plug 290 to an opening 254 in lining 250. A vibrating mechanism housing 270, comprising an on/off switch 272 is placed in opening 248 of portion 233 and opening 252 in lining 250. The structure and functionality of the vibrating mechanism are as explained for FIGS. 1 and 2.

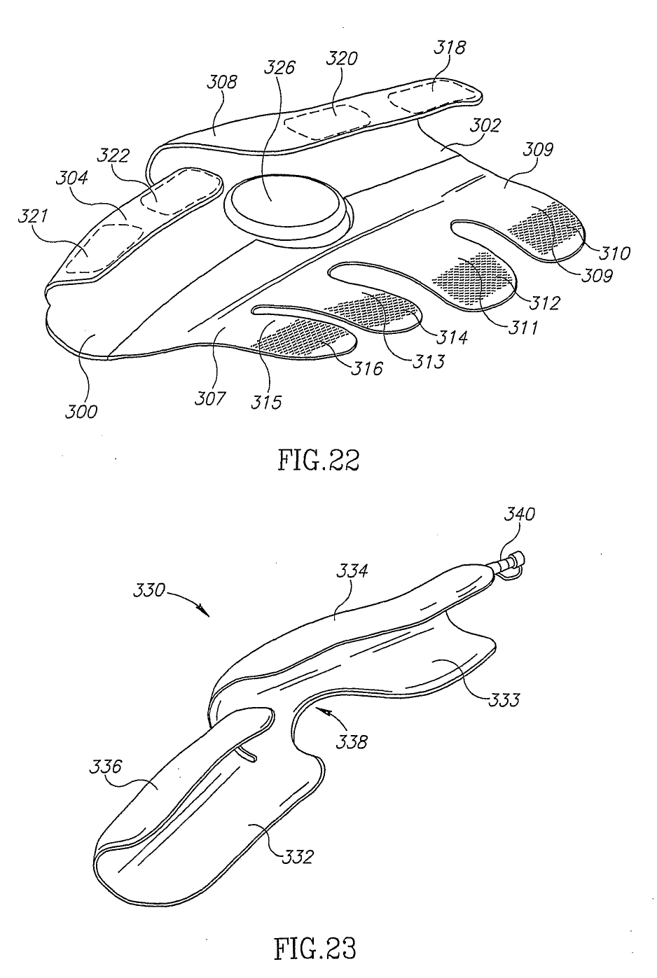

Reference is now made to FIGS. 22, 23, 24, 25, 26, 27, depicting a device for treating arthritis in a wrist of a user, in accordance with yet another embodiment of the present invention. The wrist device shown in FIGS. 22, 23, 24, 25, 26, 27 depicts two primary embodiments, namely, an embodiment that discloses the fixation of the wrist and the nearby joints, and a second embodiment that discloses a device allowing the movement of the wrist and the nearby joints.

Reference is now made to FIG. 22 that shows the rigid portions and the straps of the fixating device, in accordance with the another preferred embodiment of the present invention. Rigid portions 300, 302, 304 and 308 are preferably made of a biocompatible sturdy material such as acrylic, plastic, hardened rubber and the like. Rigid portion 300 comprises a flat rigid surface having a rectangular shape wherein the fingers, excluding the thumb, rest, and rigid portion 302 comprises a similarly flat rigid surface having a rectangular shape wherein the wrist and part of the forearm rest. The rigid portions 300, 302 can be shaped so as to fit the shape of the resting fingers, wrist and forearm. Rigid portions 300, 302 can comprise a single surface and can also have an opening 301 adjacent the location of the resting wrist. A rigid portion 304 covers the fingers on its internal side, while its external side is used as a resting place for the thumb, and a rigid portion 308 covers the wrist and the portion of the forearm that is adjacent to the wrist. Straps 309, 311, 313, and 315 are connected through a flexible portion 307 to rigid portions 300 and 302. Straps 313 and 315 are connected to rigid portion 300 and end respectively with portions 314 and 316, carrying fastening elements such as VELCRO pieces, multiple usage adhesive patches, magnetic mechanism, laces, or the like. Portions 321 and 322 placed on rigid portion 304, carry parts of the fastening elements. When the device is worn, rigid portion 304 and straps 313 and 315 wrap the fingers of the person wearing the device, and the fastening elements of portions 314 and 316 are fastened to portions 321 and 322 of rigid portion 304 over the fingers. Similarly, straps 309 and 311 are connected to rigid portion 302, and end with portions 310 and 312 carrying fastening elements. When the device is worn, rigid portion 308 and straps 309 and 311 wrap the portion of the forearm closer to the wrist, and the fastening elements of portions 310 and 312 are fastened to portions 318 and 320 of rigid portion 308. Straps 309, 311, 313, and 315, and portions 310, 312, 314, and 316, carrying the fastening elements can be made of the same material as rigid portions 300, 302, 304 and 308, but flattened to achieve flexibility and enable them to wrap the fingers and portion of the forearm. Alternatively, straps 309, 311, 313, and 315 and portions 310, 312, 314, and 316 can be made of another bio-compatible flexible material, such as elastic fabric, rubber or the like. A round opening 326 locate between rigid portions 300 and 302 is intended to accommodate a vibrating mechanism. Opening 326 can be of any required shape, for example rectangular, square, or amorphic shape, can be located anywhere on the device, and is not limited to the shown shape and location.

Referring now to FIG. 23, showing an internal lining, generally referred to as 330, that fits the wrist device. Preferably, lining 330 is made of one piece, and is structured of several portions to fit the device. Lining 330 comprises portion 332 that rests under the user's fingers, portion 333 that rests under the relevant part of the user's forearm, portion 336 that wraps the user's fingers from above, and portion 334 that wraps the forearm. Portion 338 has a semi-circle cut, to fit round opening 326 of FIG. 22. Lining 330 optionally comprises an opening 340 for filling. The properties and options related to internal lining 330 are as described in detail in the explanations relating to FIG. 8.

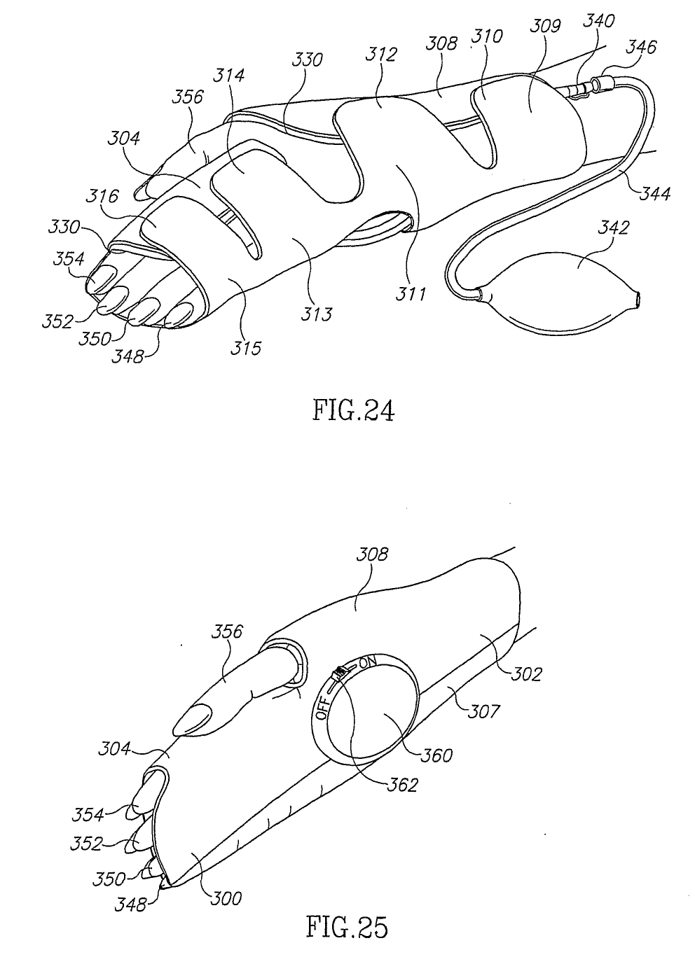

Referring now to FIG. 24, showing the hand of a user wearing the wrist device. Flaps 313 and 315, ending with fastening elements carrying portions 314 and 316, are fastened to rigid portion 304, thus wrapping the fingers 342, 344, 346, and 348. Flaps 309 and 311, ending with fastening elements carrying portions 310 and 312, are fastened to the rigid portion 308, thus wrapping the relevant portion of the forearm. The user's thumb 356 rests externally to rigid portion 304. If lining 330 is of a type that is inflated by air, a manual pump 342, connects through a tube 344 and a plug 346 to an opening 340 in lining 330.

Reference is now made to FIG. 25, showing the hand of the person using the device, from the palm. Rigid portions 300 and 302 connect to rigid portions 304 and 308. Portion 304 connects to straps 313 and 315 (not shown) starting at flexible portion 307, thus wrapping fingers 348, 350, 352, and 354. Portion 308 connects to straps 319 and 311 (not shown) starting at flexible portion 307, thus wrapping the portion of the forearm adjacent to the wrist. Thumb 356 rests externally to rigid portion 304. A housing 360, further comprising an on/off switch 362, resides inside opening 326 in rigid portions 300 and 302 of FIG. 22, and is enclosing a vibratory mechanism. The structure and functionality of the vibratory mechanism are further described in association with the description associated with FIGS. 1, 2.

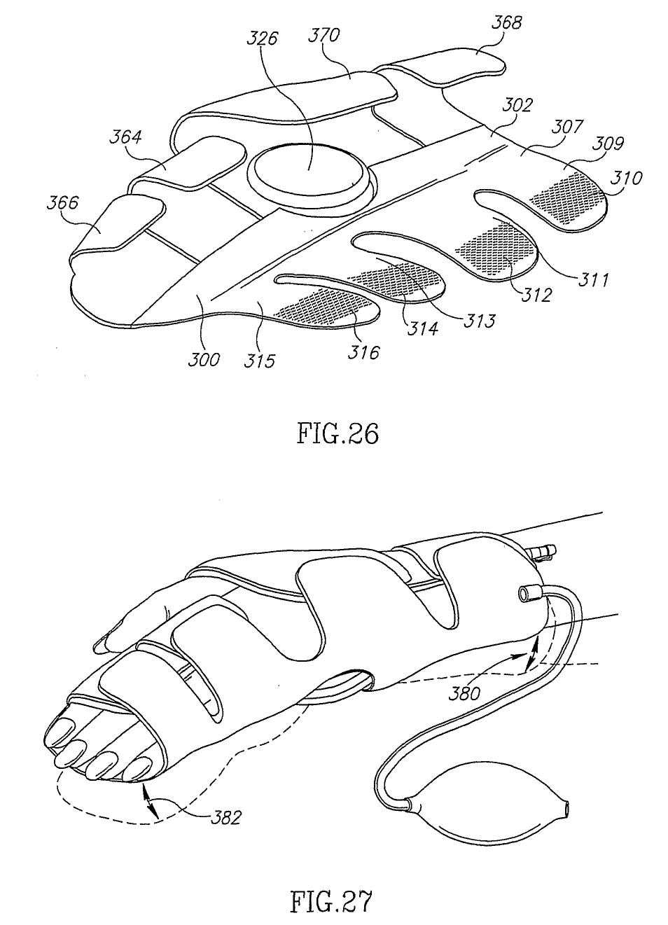

Referring now to FIGS. 26, 27, 28 and 29, showing another preferred embodiment of the wrist device, which bends and straightens the wrist and the fingers' joints while vibrating the portion. FIG. 26 shows the rigid portions of the device. As in FIG. 22, a rigid portion 300 is the fingers portion, a rigid portion 302 is the forearm portion, and a rigid portion 307 connects to straps 309, 311, 313, and 315, and portions 310, 312, 314, and 316, carrying fastening elements. However, rigid portion 304 of FIG. 22 now splits to two rigid portions, 364 and 366, and rigid portion 308 of FIG. 22 now splits to portions 368 and 370. The splits enable the movement of the wrist and palm joints. The internal lining suitable for this embodiment is also depicted and described in association with the description of FIG. 23.

FIG. 27 shows a user's hand with the device from the top. Arrows 380 and 382 represent the bending and straightening direction of the hand, resulting by using a joint moving mechanism.

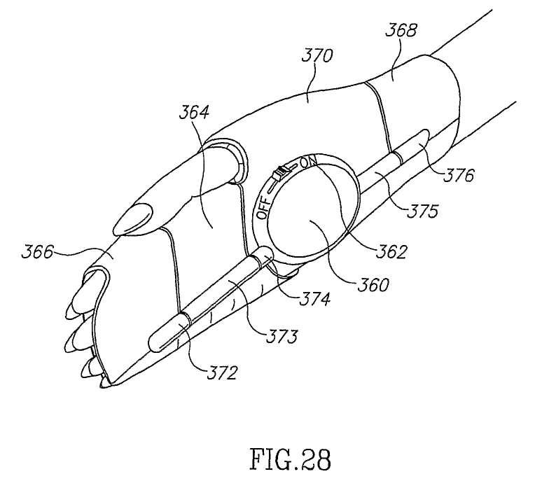

FIG. 28 shows a hand of a person wearing a joint-moving embodiment of the device, from the palm. Rigid portions 364 and 366 are under the fingers portion, and rigid portions 368 and 370 are under the wrist and the forearm portion. Housing 360 of the vibratory actuator, comprising on/off switch 362 is placed under the palm portion. Attached to housing 360 is a tubular cable housing made of three portions 372, 373, 374 located under the fingers portion of the device and two portions 375 and 376 located under the wrist and forearm portion of the device. The divisions between the portions of the tubular housing are located under the wrist and fingers' joints in the hand, and are intended to enable the bending of the joints. Housing 360 further comprises a mechanism for bending and straightening the wrist and fingers' joints.

As detailed above, the disclosed palm devices apply vibrations to all parts of the hand and wrist, and along multiple vectors, thus enhancing the effectiveness of the vibrations. The structure also allows the palm to be in neutral anatomic position or to be responsive to continuous passive motion. The disclosed devices can be used even if the palm is distorted or deformed.

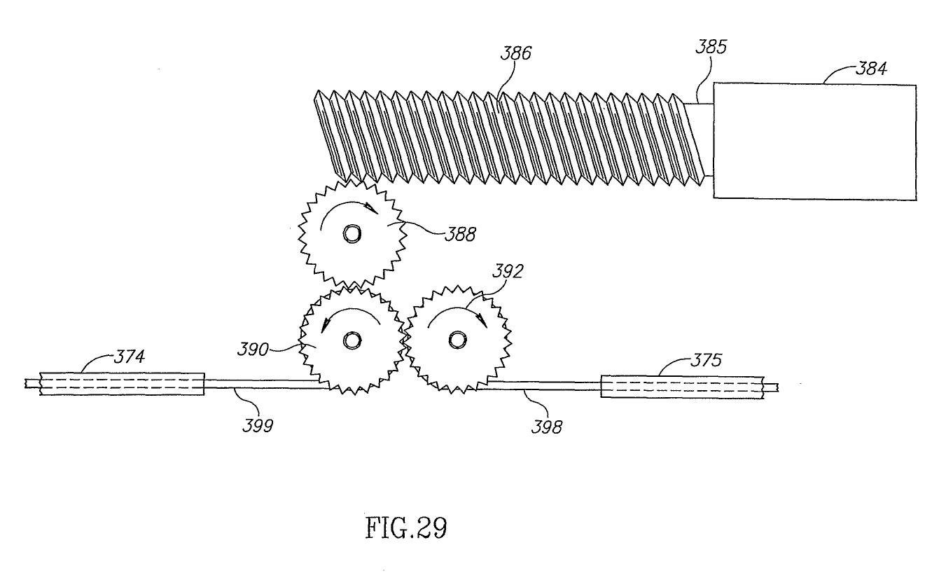

Referring now to FIG. 29, detailing a preferred embodiment of a wrist and finger joint moving mechanism. The presented embodiment is exemplary only, and other embodiments can be used as well. Actuator 384 is connected to a shaft 385, which in turn is connected to a screw 386. The screw 386 rotates a first tooth wheel 388. When first tooth wheel 388 rotates clockwise, a second tooth wheel 390 rotates counter clockwise, and pulls to the right (in the figure) a rigid cable 399 connected to it. Rigid cable 399 is strung in tubular cable housing part 374 of FIG. 28, and in the other parts of the tubular cable housing, 373, 372 of FIG. 28. The rotation of second tooth wheel 390 counter clockwise, rotates a third tooth wheel 392 clockwise. A second rigid cable 398 connected to tooth wheel 392 is then pulled to the left. Cable 398 is strung in tubular cable housing parts 375 and 376 of FIG. 28. Thus, when actuator 384 rotates in one direction, cables 398 and 399 are pulled towards each other, and the hand bends along arrows 380 and 382 of FIG. 27. When actuator 384 switches the rotating direction, tooth wheel 388 rotates counter clockwise, tooth wheel 390 rotates clockwise, thus pushing cable 399 to the left. The clockwise rotation of tooth wheel 390 rotates third tooth wheel 392 counter clockwise, thus pushing cable 398 to the right, and straightening the hand and forearm. Preferably, actuator 384 resides inside housing 360 of FIG. 28. Alternatively, it can reside in a different housing. Actuator 384 is activated simultaneously with a vibration-generating actuator. Alternatively, actuator 384 operates according to a different protocol, or at the user's discretion.

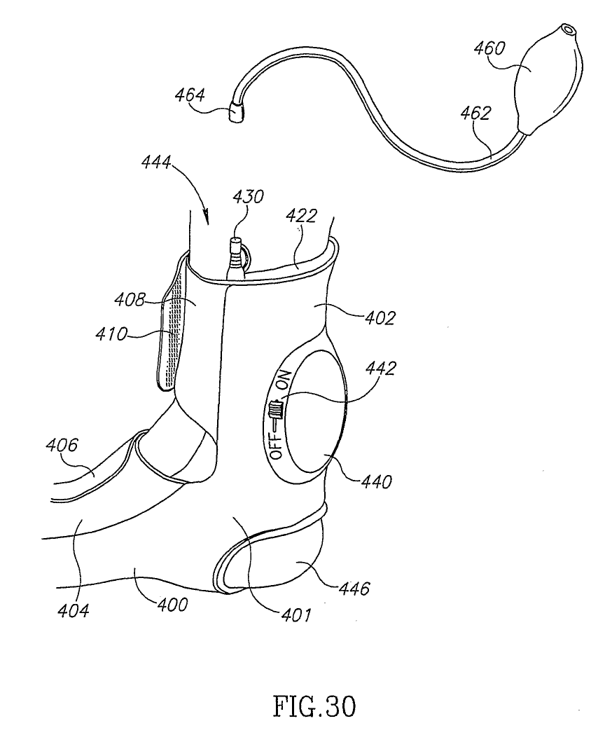

Reference is now made to FIGS. 30, 31, 32, 33, and 34, showing a device for handling arthritis and other chronic joint syndromes in an ankle of a user, in accordance with another embodiment of the present invention. Reference is now made to FIGS. 30, 31, 32, 33, and 34, disclosing a device for treating arthritis and other chronic joint syndromes in an ankle of a user, in accordance with another embodiment of the present invention. FIG. 30 shows a side view of the ankle of a person wearing a fixating ankle device around an ankle 446, which is an adaptation of the elbow device of FIG. 2 to the ankle. Rigid portions 402, 400, and 401 are preferably made of a single piece and comprise a single piece brace to support respectively the user's shin 444, foot, and ankle 446. Upper straps 408 and 410 wrap shin 444, and lower straps 404 and 406 wrap the foot. In addition, an inflatable internal lining 422 is spread between rigid portions 400, 401, 402, and the user's skin or clothes, internal lining 422 is filled through an inlet 430. If lining 422 is of a type that is inflated by air, a manual pump 460 connects through a tube 462 and a plug 464 to opening 430 in lining 422. A vibration motor housing 440 and an on/off switch 442 are located on upper rigid portion 402. In one embodiment of the present invention, the single piece brace is preferably having a substantially elongated rectangular shape, having a curvature to fit to said shin and foot, and a c-shaped opening adjacent to portion 401 to fit the ankle of the user. In the preferred embodiment, upper rigid portion 400 and lower rigid portion 402 are positioned such that a fixed angle is formed between the shin and the foot of the user wearing the device. The fixed angle is preferably an angle of between about 20 degrees and about 190 degrees. As shown in the present figure the angle created by the single piece brace is about 90 degrees allowing the joint receiving the vibrations to be relaxed.

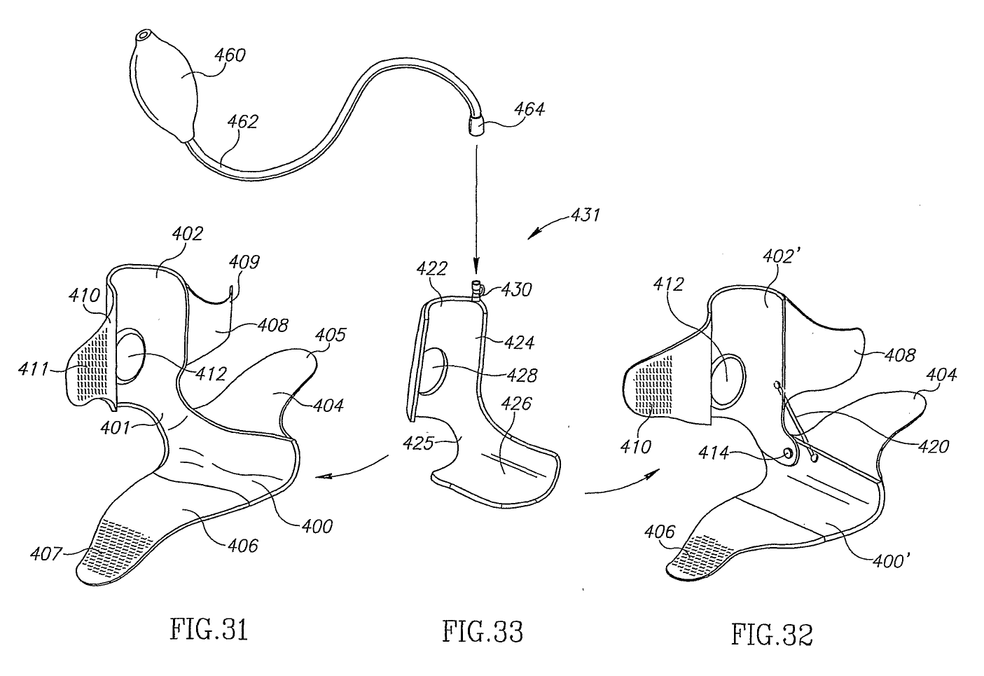

Referring now to FIG. 31 showing an illustration of an ankle fixating embodiment of the knee device of FIG. 30, in accordance with another preferred embodiment. In a preferred embodiment, upper rigid portion 402 and lower rigid portion 400 are preferably made of one piece and are rigidly connected at a connecting portion 401. The member making up portions 400, 401, and 402 is made of a biocompatible sturdy material such as acrylic, plastic, hardened rubber and the like. Upper straps 408 and 410 are connected to upper rigid portion 402 and end respectively with portions 409 and 411, carrying fastening elements such as patches comprising hooks and loops such as Velcro pieces, multiple usage adhesive patches, magnetic mechanism, laces, or the like. When the device is worn, straps 408 and 410 wrap the shin of the user of the device, and the fastening elements of portions 409 and 411 are fastened to each other over the front portion of the shin. Analogously, straps 404 and 406 are connected to lower rigid portion 400, and end with portions 405, 407 carrying fastening elements. When the device is worn, straps 404 and 406 wrap the foot of the person wearing the device, and the fastening elements of portions 405 and 407 are fastened to each other over the top portion of the foot. Straps 404, 406, 408, and 410, and portions 405, 407, 409, and 411, carrying the fastening elements can be made of the same material as rigid portions 400, 401, 402, but flattened to achieve flexibility and enable them to wrap the shin and the foot. Alternatively, straps 404, 406, 408, and 410, and the portions 405, 407, 409, and 411 can be made of another bio-compatible flexible material, such as elastic fabric, rubber or the like. A round opening 412 in upper rigid portion 402 is intended to accommodate the housing of a vibrating mechanism. Opening 412 can be of any required shape, for example rectangular, square, or amorphic shape, and can be located anywhere on the device, and is not limited to the shown shape and location.

Referring now to FIG. 32, showing another preferred embodiment for the ankle device, which is an adaptation of the elbow device of FIG. 3 to the ankle. As in FIG. 31, straps 404, 406, 408, and 410 and regions 405, 407, 409, and 411 are wrapped and fastened around the shin and the foot of a user. Unlike the device shown in FIG. 31, upper rigid member 400′ and lower rigid member 402′ are separate, and are connected to each other by pivots, such as a pivot 414 or any other connection mechanism that allows members 400′, 402′ to move relatively to each other. When using the device, members 400′, 402′ can move relatively to each other, thus causing the contraction and extension of the ankle. Alternatively, when the user extends or contracts the ankle, members 400′ and 402′ move relatively to each other. In an alternative embodiment, a rod 420 is a part of the mechanism that moves upper rigid member 402′ and lower rigid member 400′ relatively to each other when the device is used. As noted in association with FIG. 31 the pivot 414 enables the fixating of the members 400′, 402′ such that a fixed changeable angle is created there between.

Referring now to FIG. 33, showing an internal lining designed for the ankle device, generally referenced as 431. The properties and options related to internal lining 431 were described in detail in the explanations relating to FIG. 8. The structure of internal lining 431 is designed to fit the rigid portions of the ankle devices, as shown in FIG. 31 and FIG. 32. A main portion 425 fits connecting portion 401 of FIG. 31 or the portion of pivot 414 of FIG. 32, portions 400 and 402 of FIG. 31, or members 400′ and 402′ of FIG. 32. A round opening 428 is designed to be located congruently to opening 412 in upper rigid portion 402 or in member 402′. The vibrations actuator (not shown) is inserted into openings 428 and 412. An inlet 430 uses for filling internal lining 431 with the relevant substance, in case the lining is of a refillable type.

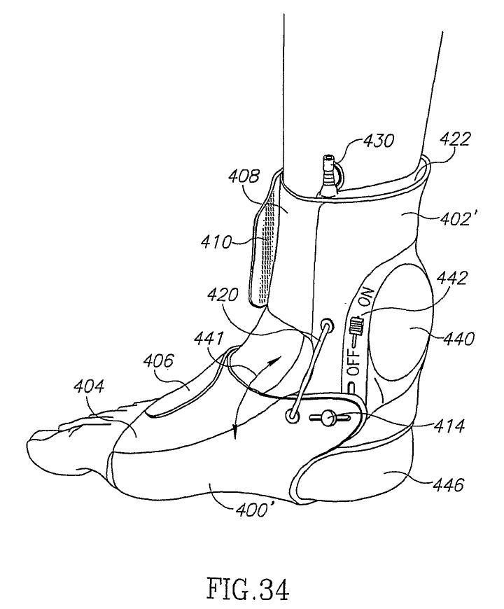

FIG. 34 shows a leg of a user wearing the ankle device shown in FIG. 32. Rigid members 400′ and 402′ support the user's shin and foot, around the ankle 446. Straps 408 and 410 are wrapped around the shin, straps 404 and 406 are wrapped around the foot, and a lining 422 rests between rigid members 400′ and 402′ and the skin or the clothes of the person. A housing 440, enclosing a vibratory mechanism, is located inside opening 428 in lining 431 of FIG. 32, and opening 412 in the rigid member 402′ of FIG. 32, if openings 428 and 412 exist. Alternatively, housing 440 is attached to any of the rigid members of the ankle device. The structure and functionality of the vibratory mechanism are as explained in association with FIGS. 6 and 7. Housing 440 further comprises an on/off switch 442 or a mechanism for extending and contracting the ankle, which optionally employs a rod 420. A plurality of embodiments for the extending and contracting mechanism can be used, such as the abovementioned exemplary mechanisms shown and described above in FIG. 9 and FIG. 10. A better understanding of the changeable and fixed angles created by the design of the device can be appreciated from the view provided in FIG. 34 wherein the angle 441 between the members 400′, 402′ as shown on the lateral side of the device. Angle 441 can be changed by the movement of rod 420. In an alternative embodiment wherein rod 420 is not present, the angle 441 can be changed by the manual alteration of the position of pivot 414, which is shown as a screw able hinge, through the opening of the hinge and altering the position of members 400′ and 402′ and are securing of said hinge into place.

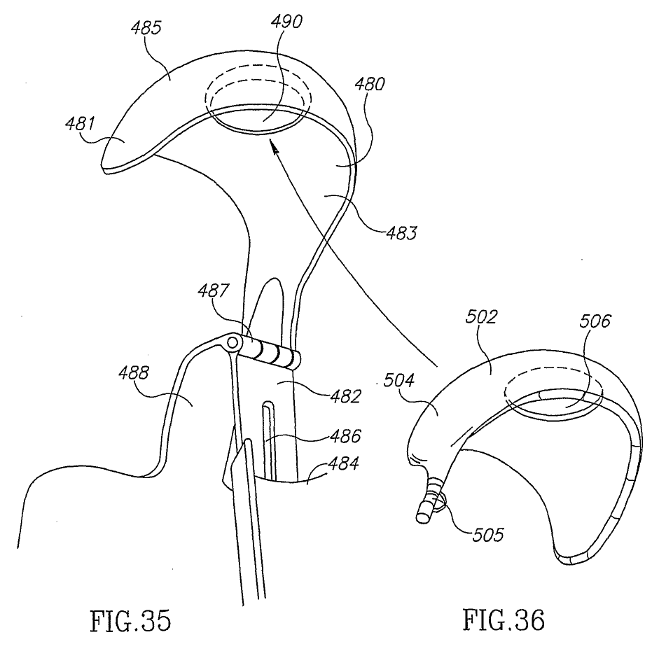

Reference is now made to FIGS. 35, 36, 37, and 38 describing a device for treating arthritis and chronic joint symptoms in the shoulder of a user.

FIG. 35 shows the rigid portions of the shoulder device, comprising a shoulder member 480, an arm supporting member and a body supporting member 488. The shoulder supporting member comprises a cap 485 that fits around the shoulder, a pointed portion 481 that is to be placed behind the shoulder, and a neck-like portion 483 that is to be placed frontally to the shoulder and under the user's arm. The shoulder member further comprises a opening 490 for the vibration-generating mechanism. The arm-supporting member comprises a flat member 482, which is connected to shoulder member 480 by a pivot 487 or any other connecting mechanism. The arm-supporting member further comprises a rounded portion 484 connecting to a flat member 482. The connection and the height adaptation between rounded portion 484 and flat member 482 is obtained by using a vertical slot 486 and a screw (not shown) connected to rounded member 484, that is to be fixed anywhere along slot 486, according to the required location of the arm-support member. The device further comprises a body-support member 488 that is leaned on the side of the body when the device is used. Rigid members 480, 482, 484, and 488 are made of a biocompatible sturdy material such as acrylic, plastic, hardened rubber and the like.

Referring now to FIG. 36, showing the internal lining of the device, generally referenced as 502. The properties and options related to internal lining 502 are as described in detail in the explanations relating to FIG. 3. The structure of internal lining 502 is designed to fit capped portion 485 of the shoulder device, as shown in FIG. 35. A main portion 504 of the lining 502 fits capped rigid portion 485 of FIG. 35. A round opening 506 is designed to overlap round opening 490 in capped portion 485 of FIG. 35. The vibration-generation mechanism (not shown) is inserted into openings 490 of FIG. 35 and 506 of FIG. 36. A filling connection 504 is used for filling internal lining 502 with the relevant substance, in case internal lining 502 is of a refillable type.

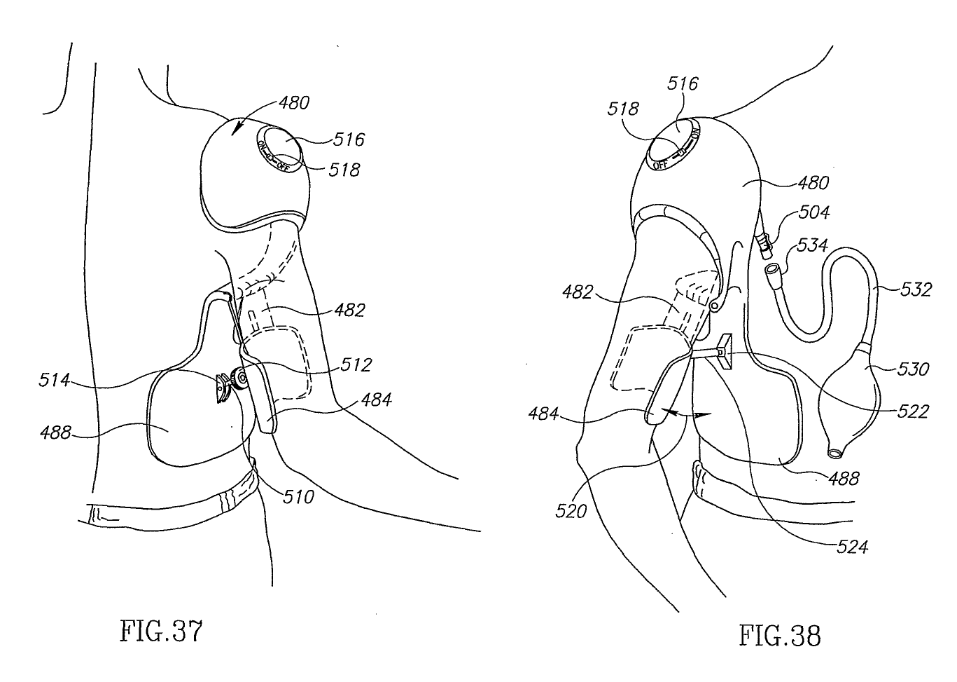

FIG. 37 presents a user wearing a preferred embodiment of the shoulder device. The device comprises shoulder member 480, flat portion 482 of the arm-supporting member, rounded portion 484 of the arm-supporting member and side-supporting member 484. A vibratory actuator housing 516 comprising an on-off switch 518 reside opening 506 in internal lining 502 of FIG. 36 and opening 490 in rigid portion 480 of FIG. 35. The device further comprises a mechanism for adjusting the angle at which the hand is positioned relatively to the body. The mechanism comprises a piston 510, a member 514 for attaching the piston 510 to the body-supporting member 488, and an adjustment mechanism 512, for adjusting the arm at a convenient angle relatively to the body.

Referring now to FIG. 38, showing a user wearing another preferred embodiment of the proposed shoulder device. Rigid members 480, 482, 484, and 488, actuator 516 and switch 518 are as explained for FIG. 35. If the internal lining (not shown) is of a type that is inflated by air, a manual pump 530 connects through a tube 532 and a plug 534 to an opening 504 in the lining. Unlike the embodiment shown in FIG. 35, in this embodiment the arm is not fixed at a static position relatively to the body throughout the activation of the device, but is rather moved in a direction shown by an arrow 520. The shoulder moving mechanism (not shown) is using a shaft 524 and is attached to body supporting member 484 by a base 522.

As shown, the disclosed ankle and shoulder devices apply vibrations to all parts of the ankle or the shoulder, and along multiple vectors, thus enhancing the effectiveness of the vibrations. The disclosed devices can be used even if the joint is distorted or deformed, and allow said joints to be in neutral anatomic position or to be responsive to continuous passive motion.

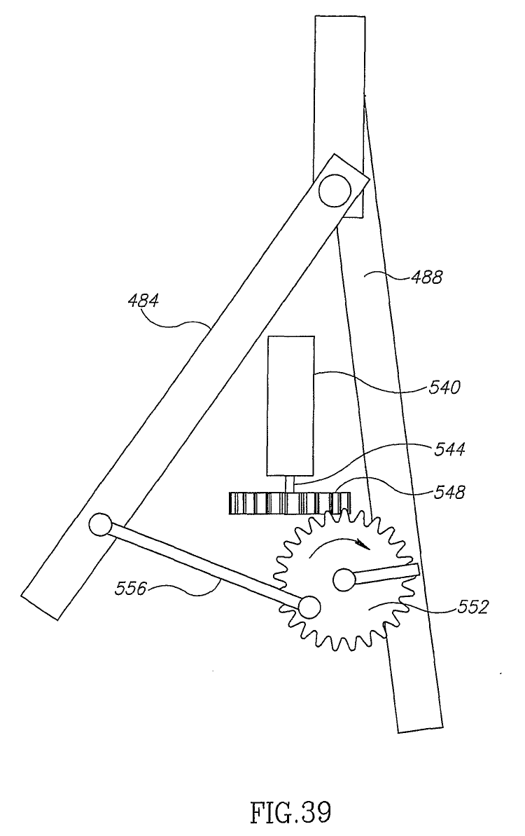

Referring now to FIG. 39, depicting an exemplary mechanism for moving the hand and thus the shoulder. A actuator 540 rotates, causing a shaft 544 connected to it to rotate as well. Shaft 544 is connected to the center of a tooth wheel 548, such that when the shaft rotates, so does tooth wheel 548. The teeth of tooth wheel 548 are interlaced with the teeth of a second tooth wheel 552 which is perpendicular to tooth wheel 548, and connected to body supporting member 488. A rod 556 is connected on one end to tooth wheel 552 in an eccentric manner, and on the other end to arm-supporting member 484. Therefore, when actuator 540 spins, the end of rod 556 that is connected to tooth wheel 552 spins around the center of tooth wheel 552, thus activating the shoulder by pushing and pulling the arm-supporting member 484 and the arm, relatively to body-supporting member 488 and the body.

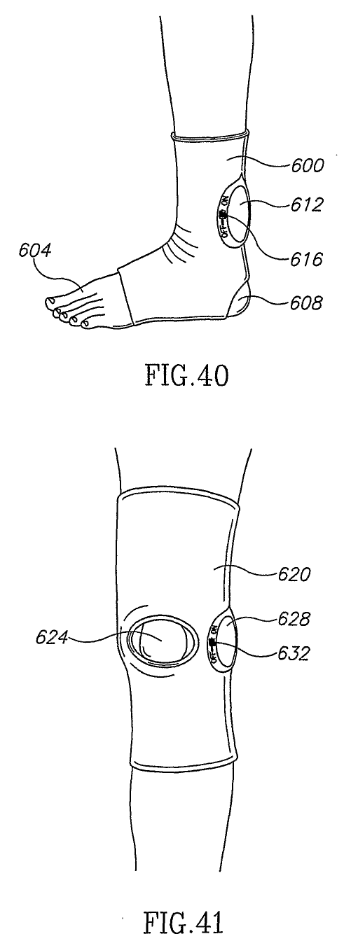

Referring now to FIGS. 40, 41, 42, 43, 44, which show devices comprising soft portions rather than rigid portions surrounding the joints, in accordance with preferred embodiments of the disclosed invention. Such devices should include a flexible but strong member, which fits tightly around a joint, the member should be structured in a way that will support the joint but will enable the joint to flex and straighten, and optionally straps to improve the fitting to the joint. All devices should include a rotation motor attached to the flexible member, said rotation motor similar to the motors described above. The devices optionally comprise straps in order to improve the attachment of the device to the relevant joint and surrounding area. Other devices for providing vibrations can be used instead of vibrating motors, including any type of actuator currently known or that will be known in the future, such as electrical, magnetic or electromagnetic motor.

Referring now to FIG. 40, showing a device designed to fit around the ankle of a user. The device comprises a semi-rigid or flexible but firm member 600, preferably made of stretchable cloth such as a cotton, linen, or polyester combined with Lycra or another elastic fiber. Member 600 is designed substantially like a sock, with openings or other adjustments for the user's hill 608 and optionally for the user's toes. The openings can be replaced with loose material, preshaped material or any other feature. The device further comprises a housing 612 enclosing a vibratory mechanism (not shown) and an on-off switch 616. The housing can be placed in an opening in member 600, or externally to member 600 and attached to member 600 by any standard means such as Velcro straps, snaps or the like. Soft member 600 further comprises elastic stitches or additional material 612, which enables the user to flex and point the ankle freely.

FIG. 41 shows a flexible device designed to fit around the user's knee and the parts of the hip and shin close to the knee. The device presented in FIG. 41 comprises a flexible but firm member 620 comprising an opening 624 for the kneecap to protrude through when the knee is bent. Firm member 620 can alternatively comprise loose areas or preshaped material instead of the opening for the kneecap, to allow for bending of the knee. Member 620, similar to member 600 of FIG. 40 is made of flexible material such as cotton, possibly combined with flexible fibers such as Lycra. Motor housing 628, comprising on-off switch 632 is attached to member 620 as described in association with FIG. 40 hereinabove.

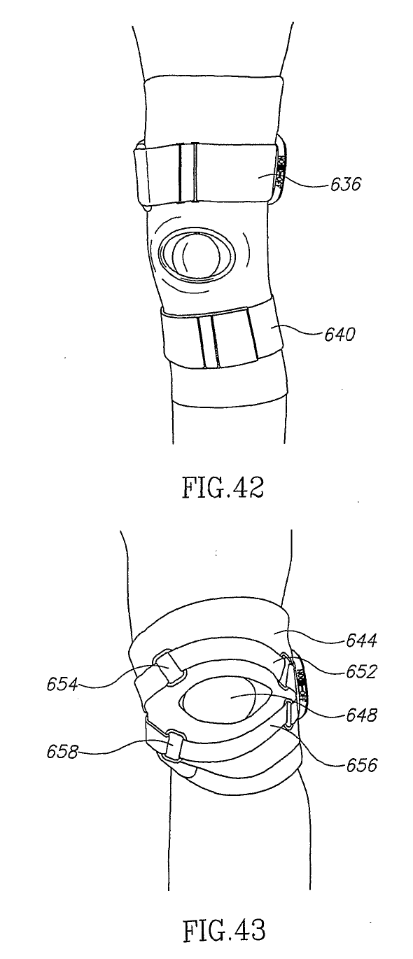

FIG. 42 shows a device similar to the device shown in FIG. 41, comprising extra straps 636 and 640. Straps 636 and 640 are fastened around the hip and shin, respectively, using a buckle, Velcro patches or any other fastening mechanism.

FIG. 43 also shows a device designed to fit around a user's knee. The device comprises a firm but flexible member 614, an opening or another adjustment mechanism for kneecap 648 and two straps 652 and 656. Strap 652 comprises a buckle 654 and strap 656 comprises a buckle 658 to enable fitting the strap sizes. Alternatively, the straps can be fitted using Velcro patches or any other mechanism. Member 644 is wider on the front part than on the rear part, to enable easy bending of the knee. Optionally, member 644 comprises stitches or additional material on the rear part to enable flexing the knee. Firm member 620 can alternatively comprise loose areas or preshaped material instead of the opening for the kneecap, to allow for bending of the knee.

As shown, the devices of FIGS. 40, 41, 42 and 43 apply vibrations to all parts of the user's relevant joint, and along multiple vectors, thus enhancing the effectiveness of the vibrations. The disclosed devices can be used even if the joint is distorted or deformed, and allow said joints to be in neutral anatomic position.

It will be appreciated by persons skilled in the art that the devices shown in FIGS. 40, 41, 42 and 43 are exemplary only. Various additional flexible models can be designed to fit the above-mentioned joints or other joints, such as the elbow, the shoulder, the hip, or the wrist.

In addition, a device can be designed, which comprises two sleeve-like parts each equipped with a vibrating mechanism. The two parts are wrapped around two body parts connected by a joint. For example, the parts can be wrapped around the hip and shin thus vibrating the knee of the user from multiple directions, or around the arm and forearm thus vibrating the elbow of a user.

The proposed devices and principles propose a novel treatment for arthritis and other chronic joint symptoms. The treatment includes introducing vibrations to the joint and its region, while fixating the joint, enabling the joint to move or deliberately moving the joint in predetermined directions and ranges. The devices are portable and easy to use, and the treatment is painless, pleasant, and provides immediate pain reduction as well as function improvement and delayed disability.

The proposed embodiments for the devices are exemplary only and are intended merely for indicating possible embodiments facilitating the presented principles. The presented components of the proposed invention can be used separately or concurrently. A device can be used with one type of lining or another, or with no lining at all, while the device itself is of a fixating type or of a joint-moving type. More than one device can be used simultaneously, with identical, similar or different activation protocols. Embodiments other than the shown can be used for the discussed joints, and additional devices using the disclosed principles can be designed for further joints, such as the neck, the hip, the spine, the jaws, the nose and others. Another possible embodiment comprises introducing two or more vibratory mechanisms into one of the above-mentioned devices. In addition, simpler embodiments, comprising a strap with or without lining and one or more vibration mechanisms are possible as well. Given such embodiment, a combination of two or more such straps can be used, for examples on two sides of a joint, thus also providing the user with vibrations from multiple directions.

It will be appreciated by persons skilled in the art that the present invention is not limited to what has been particularly shown and described hereinabove. Rather the scope of the present invention is defined only by the claims which follow.

1.-112. (canceled)

113. A vibrating brace, for introducing vibrations to a joint and a location in the vicinity of the joint of a user of the device useful in vibrating at least two body parts adjacent to said joint, said device comprising a vibrating assembly (VA) and at least one connecting portion (CP), said VA is connected with said CP; wherein said CP is connected with at least a first and second brace-like wrapping member for bracing and wrapping first and second body parts adjacent to said joint; and further wherein said VA, CP and said at least first and second brace-like wrapping members are so disposed about said joint that operating said VA provides vibration to each of the said at least first and second body parts adjacent to said joint.

114. The device of claim 113 wherein said at least one wrapping member comprises a brace having an upper rigid portion 102, a lower rigid portion 104 and a connecting portion 105 preferably made of a single piece.

115. The device of claim 114 wherein said wrapping member further comprises at least 2 rigid members connected via an adjustable pivot.

116. The device of claim 114 wherein the vibrations affect one or more elements in the joint or in the area of the joint from the group consisting of: a bone; a connecting tissue; a muscle; a tendon; a nerve; a blood vessel; a synovial; synovial fluid; or skin.

117. The device of claim 114 wherein said vibrations are transported to the joint along multiple vectors.

118. The device of claim 114 further comprising a mechanism for application of passive continuous motion to the joint.

119. The device of claim 114 wherein the vibrating mechanism comprises a power source, and a vibrating assembly and a controller for activating and deactivating the vibrating assembly such that vibrations are provided according to a predetermined protocol.

120. The device of claim 114 wherein the vibrating mechanism comprises a component selected from a group consisting of piezoelectric actuator, Electric Active Polymer actuator or any electromechanical actuator, said component designed to vibrate at the frequency range of about 0.5 Hz to about 500 Hz.

121. The device of claim 114 wherein the lining member is cooled or heated prior to attaching the device to the joint of the patient.

122. A method, for introducing vibrations to a joint and a location in the vicinity of the joint such that at least two body parts adjacent to said joint vibrate as a single piece, said method comprising steps of;
obtaining at least a first and second brace-like wrapping member, bracing and wrapping said first and second body parts with said at least first and second brace-like wrapping members respectively;
connecting said CP to at least first and second brace-like wrapping member;
attaching said VA to said CP operating said VA thereby introducing vibrations to a joint and a location in the vicinity of the joint such that at least two body parts adjacent to said joint vibrate.

123. A method according to claim 122 wherein said method further comprises a step of introducing vibrations affecting one or more elements in said joint or in the area of the joint from the group consisting of: a bone; a connecting tissue; a muscle; a tendon; a nerve; a blood vessel; a synovial; synovial fluid; or skin.

124. A method according to claim 122 wherein said method further comprises a step of transporting said vibrations to the joint along multiple vectors.

125. A method according to claim 122 wherein said method further comprises applying passive continuous motion to the joint.

126. A method according to claim 122 wherein said method further comprises obtaining a wrapping member comprising of at least 2 rigid members and connecting said at least 2 rigid members by means of an adjustable pivot.

127. A method according to claim 122 wherein said method further comprises obtaining a vibrating mechanism, said mechanism comprises a power source, and a vibrating assembly and a controller for activating and deactivating the vibrating assembly, thereby providing vibrations according to a predetermined protocol.

128. The method according to claim 122 wherein said method further comprises a step of obtaining a vibrating mechanism comprising a component selected from a group consisting of a piezoelectric actuator, Electric Active Polymer actuator or any electromechanical actuator, said component designed to vibrate at the frequency range of about 0.5 Hz to about 500 Hz.

129. The method of claim 122 wherein said method comprises a step of cooling or heating a portion of said prior to attaching the device to the joint of the patient.
